(19) United States
(12) Patent Application Publication
(10) Pub. No.: US 2022/0158189 A1
(43) Pub. Date: May 19, 2022

(54) PROCESS FOR PRODUCING A SHAPED ORGANIC CHARGE STORAGE UNIT

(71) Applicant: Evonik Operations GmbH, Essen (DE)

(72) Inventors: Sébastien COCHET, Ratingen (DE); Andreas Wild, Haltern am See (DE); Michael Korell, Bochum (DE)

(73) Assignee: Evonik Operations GmbH, Essen (DE)

(21) Appl. No.: 17/438,859

(22) PCT Filed: Dec. 4, 2019
(86) PCT No.: PCT/EP2019/083579

§ 371 Date: Sep. 13, 2021

(30) Foreign Application Priority Data
Mar. 14, 2019 (EP) 19162780.1

(51) Int. Cl. H01M 4/60; H01M 10/0565; H01M 4/86

(52) U.S. Cl. CPC H01M 4/608; H01M 10/0565; H01M 2300/0082; H01M 2300/0085; H01M 4/8673

(57) ABSTRACT

A process produces a shaped organic charge storage unit, especially a secondary battery, the electrodes of which contain an organic redox-active polymer, and which includes a polymeric solid electrolyte. Compared to conventional folded charge storage units, the charge storage unit shows greater resistance to deformation, which is manifested in a lower drop in capacity and a reduced tendency to fracture in the shaping process.

The present invention relates to a process for producing a shaped organic charge storage unit, especially a secondary battery, the electrodes of which comprise an organic redox-active polymer, and which includes a polymeric solid electrolyte. The present invention additionally also relates to the shaped organic charge storage unit itself. By comparison with those from the prior art, the charge storage unit of the present invention shows greater resistance to deformation, which is manifested in a reduced tendency to fracture in the shaping process.

### BACKGROUND OF THE INVENTION

Charge storage units, for example secondary batteries, find various uses in sectors in which they are exposed to high mechanical stresses.

For example, batteries are required in the field of patient-centred laboratory diagnostics, where they are applied to flexible substrates such as paper, textiles or bandage material.

There is also a need in the sports sector for electronic measuring devices that measure various body functions such as heartbeat, calories burnt etc., and are worn on the body by sportspeople. Such measuring devices and the batteries included therein require high mechanical stability and a small space requirement since they are worn on the body and, when they are applied to textiles, for example, are subjected to mechanical shear forces and impacts as a result of the movement of the wearer.

In addition, in the consumer goods and electrical industry, there is also a need for batteries that are applied to a flexible substrate and can be shaped without losing their ability to function. This is the case, for instance, for housings of electronic toys, electronic musical instruments or electronic joke articles.

The production of packaging material often entails the deformation of the articles by stretching or compressing, which also affects electrodes applied thereto if they do not have adequate mechanical durability.

For these purposes, the prior art describes various durable and shapable charge storage units.

WO 2015/160944 A1 describes a metal-based battery applied to paper that can be used for wearable electronic devices.

WO 2015/100414 A1 describes a shapable lithium ion battery that can be applied to packaging material, for example.

However, these batteries described in the prior art have the disadvantage that they do not have good resistance to the mechanical stresses associated with the applications described above. In addition, for example, the batteries described in WO 2015/160944 A1 are primary batteries that cannot be recharged. The batteries described in WO 2015/100414 A1 are difficult to produce and contain heavy metals and toxic liquid electrolytes that can escape easily.

There is thus a need for flexible, durable charge storage units that do not have the aforementioned problems and feature high mechanical durability. There is also a need for efficient organic charge storage units having high capacities.

### DETAILED DESCRIPTION OF THE INVENTION

A process has now been found for producing a shaped organic charge storage unit that solves these problems.

It has namely been found that, surprisingly, organic redox-active polymers have high mechanical stability and are therefore of particularly good suitability for use in shaped, especially folded, organic charge storage units. Flexibility and mechanical durability is especially assisted by the combination with a polymer electrolyte. As a result, the charge storage units according to the invention are printable, rapidly producible, and by virtue of their shapability assure better utilization of the space provided.

Improved mechanical stability is observed especially with respect to folded metal-based charge storage units, which break more often in the production process compared to the batteries according to the invention that are based on organic redox polymers.

In addition, the charge storage units according to the invention are organic and can thus be employed in fields of use that are closed to the prior art metal-based batteries, which are of concern in respect of health. The charge storage unit according to the invention also features a high capacity.

### 1. First Aspect: Process for Producing a Shaped Organic Charge Storage Unit

In a first aspect, the present invention relates to a process for producing a shaped organic charge storage unit L_{org}, which is preferably a secondary battery, comprising the following steps:

a) applying a mixture M₁ comprising at least one organic redox-active polymer P_{redox1}, at least one conductivity additive L₁, at least one solvent Solv₁, optionally at least one binder additive B₁ and optionally at least one ionic liquid IL₁ to a substrate S₁,
b) at least partly removing the solvent Solv₁,
to obtain an electrode E₁ applied to the substrate S₁;
c) applying a polymer electrolyte Pₑₗ to the electrode E₁;
d) applying a mixture M₂ comprising at least one organic redox-active polymer P_{redox2}, at least one conductivity additive L₂, at least one solvent Solv₂, optionally at least one binder additive B₂ and optionally at least one ionic liquid IL₂ to the polymer electrolyte Pₑₗ,
e) at least partly removing the solvent Solv₂,
to obtain an electrode E₂ applied to the polymer electrolyte Pₑₗ;
f) applying a substrate S₂ to the electrode E₂;
to obtain an organic charge storage unit L_{org};
characterized in that
g) the substrate S₁ is shaped in the region of the substrate S₁ covered by the electrode E₁ to obtain a shaped organic charge storage unit L_{org}.

The process according to the invention enables the production of organic charge storage units that have been shaped and are usable in a more versatile manner compared to conventional shaped charge storage units. This enables the use of the charge storage units produced by the process according to the invention on non-planar surfaces, for example when a battery has to be mounted on a corner or on concave or convex surfaces. The invention thus opens up new space-saving options for mounting a charge storage unit with high fracture resistance, for instance in packaging, toys, laboratory diagnostics, bandage material, cosmetics, clothing, especially sports clothing, aquarium equipment (filter, heating, electric thermometer for smaller aquaria), musical instruments. A further field of use in which space-saving solutions are being sought is that of smartphones or TV appliances, especially those having a flexible surface/display, which accordingly also require a charge storage unit that assures and tolerates corresponding flexibility. For these fields of use too, it is possible to use the charge storage unit L_{org} according to the present invention.

### 1.1 Step (a) of the Process According to the Invention

In step a) of the process according to the invention in the first aspect of the invention, a mixture M₁ comprising at least one organic redox-active polymer P_{redox1}, at least one conductivity additive L₁, at least one solvent Solv₁, optionally at least one binder additive B₁ and optionally at least one ionic liquid IL₁ is applied to a substrate S.

### 1.1.1 Substrate S₁

The substrate S₁ is especially selected from conductive materials, preferably from the group consisting of metals, carbon materials, oxide substances. These conductive materials may form the substrate S₁ on their own or, as is preferred in the present invention, may have been applied to nonconductive materials such as, in particular, a material selected from the group consisting of plastics, which are especially polyethylene terephthalate (=PET) or polyurethane, textiles, cellulose, especially paper, wood. Useful substrates S₁ include cellulose fibres coated with carbon nanotubes (CNTs) (production described in WO 2015/100414, paragraphs [0104], [0105]). Further preferred substrates S₁ are metal foils.

Metals that are preferentially suitable as substrate S₁ and may also be used in the form of nanoparticles or foils are selected from silver, platinum, gold, iron, copper, aluminium, zinc or a combination of these metals. Preferred carbon materials suitable as substrate are selected from carbon black, glassy carbon, graphite foil, graphene, carbon skins, carbon nanotubes (CNTs). Preferred oxide substances suitable as substrate S₁ are selected, for example, from the group consisting of indium tin oxide (ITO), indium zinc oxide (IZO), antimony zinc oxide (AZO), fluorine tin oxide (FTO) or antimony tin oxide (ATO), zinc oxide (ZO). Substrates S₁ used may also be mixtures of the groups mentioned, for example mixtures of metals and carbon materials, for example silver with carbon.

The form of the substrate S₁ in step (a) is not subject to further restriction. However, it is preferable that the substrate S₁ is planar at least in the region in which the mixture M₁ is applied in the subsequent step (b), which means that the surface of the substrate S₁ on which the mixture M₁ is applied in step (b) of the process according to the invention in the first aspect of the invention is in a plane.

The use of a planar substrate S₁ has the advantage that the application of uniform layers as described hereinafter is more easily possible.

### 1.1.2 Mixture M₁

The mixture M₁ used in step a) of the process according to the invention comprises at least one organic redox-active polymer P_{redox1}, at least one conductivity additive L₁, at least one solvent Solv₁, optionally at least one binder additive B₁ and optionally at least one ionic liquid IL₁.

The mixture M₁ is especially an electrode slurry, especially a solution or suspension, with which the constituents of the electrode E₁ obtained at a later stage are applied to the substrate S₁.

### 1.1.2.1 Organic Redox-Active Polymer P_{redox1}

The polymers usable as organic redox-active polymer P_{redox1} that are included in the mixture M₁ are known to those skilled in the art and are described, for example, in US 2016/0233509 A1, US 2017/0114162 A1, US 2017/0179525 A1, US 2018/0108911 A1, US 2018/0102541 A1, WO 2017/207325 A1, WO 2015/032951 A1. An overview of further usable organic redox-active polymers is given by the article S. Muench, A. Wild, C. Friebe, B. Häupler, T. Janoschka, U.S. Schubert, Chem. Rev. 2016, 116, 9438-9484.

The polymers P_{redox1} can be obtained by methods known to those skilled in the art.

The corresponding methods are summarized by S. Muench, A. Wild, C. Friebe, B. Häupler, T. Janoschka, U.S. Schubert, Chem. Rev. 2016, 116, 9438-9484.

In addition, the synthesis of the polymers P_{redox1} comprising a redox-active aromatic imide function is described in WO 2015/003725 A1 and U.S. Pat. No. 4,898,915 A.

In addition, polymers P_{redox1} comprising a redox-active aromatic function comprising at least one stable oxygen radical and the synthesis of the corresponding polymers P_{redox1} are also known to the person skilled in the art from WO 2017/207325 A1, EP 1 752 474 A1, WO 2015/032951 A1, CN 104530424 A, CN 104530426 A, T. Suga, H. Ohshiro, S. Sugita, K. Oyaizu, H. Nishide, Adv. Mater. 2009, 21, 1627-1630 and T. Suga, S. Sugita, H. Ohshiro, K. Oyaizu, H. Nishide, Adv. Mater. 2011, 3, 751-754.

In addition, the synthesis of polymers P_{redox1} comprising a redox-active anthraquinone/carbazole function and the synthesis of the polymers P_{redox1} comprising a redox-active benzoquinone function is also described in, or is possible as a matter of routine for the person skilled in the art on the basis of his knowledge in the art from, WO 2015/132374 A1, WO 2015/144798 A1, EP 3 279 223 A1, WO 2018/024901A1, US 2017/0077518 A1, US 2017/0077517 A1, US 2017/0104214 A1, D. Schmidt, B. Häupler, C. Stolze, M. D. Hager, U.S. Schubert, J. Polym. Sci., Part A: Polym. Chem. 2015, 53, 2517-2523, M. E. Speer, M. Kolek, J. J. Jassoy, J. Heine, M. Winter, P. M. Bieker, B. Esser, Chem. Commun. 2015, 51, 15261-15264 and M. Baibarac, M. Lira-Cantú, J. Oró Sol, I. Baltog, N. Casañ-Pastor, P. Gomez-Romero, Compos. Sci. Technol. 2007, 67, 2556-2563.

In addition, the synthesis of polymers P_{redox1} comprising a redox-active dialkoxybenzene function is also described in WO 2017/032583 A1, EP 3 136 410 A1, EP 3 135 704 A1, WO 2017/032582 A1, P. Nesvadba, L. B. Folger, P. Maire, P. Novak, Synth. Met. 2011, 161, 259-262; W. Weng, Z. C. Zhang, A. Abouimrane, P. C. Redfern, L. A. Curtiss, K. Amine, Adv. Funct. Mater. 2012, 22, 4485-4492.

In addition, the synthesis of polymers P_{redox1} comprising a redox-active triphenylamine function is also described in JP 2011-74316 A, JP 2011-74317 A.

In addition, the synthesis of polymers P_{redox1} comprising a redox-active viologen function is also described in CN 107118332 A.

In addition, the synthesis of polymers P_{redox1} comprising a redox-active ferrocene function is also described in K. Tamura, N. Akutagawa, M. Satoh, J. Wada, T. Masuda, Macromol. Rapid Commun. 2008, 29, 1944-1949.

The organic redox-active polymer P_{redox1} is preferably selected from the group consisting of polyimides and polymers comprising m units of the general formula (III):

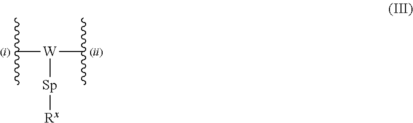

where m is an integer ≥4, preferably an integer ≥10, more preferably an integer ≥100, even more preferably an integer in the range of 1000 to 10⁹, yet more preferably an integer in the range of 2000 to 10 000, W is a repeat unit, Sp is an organic spacer and R^{X} is an organic redox-active group, where the bond identified by (i) in a unit of the formula (III) binds to the bond identified by (ii) in the adjacent unit of the formula (III).

R^{X} in the structure (III) is preferably selected from the group consisting of compounds of the general formulae (III-A), (III-B), (III-C), (III-D), (III-E), (III-F) where

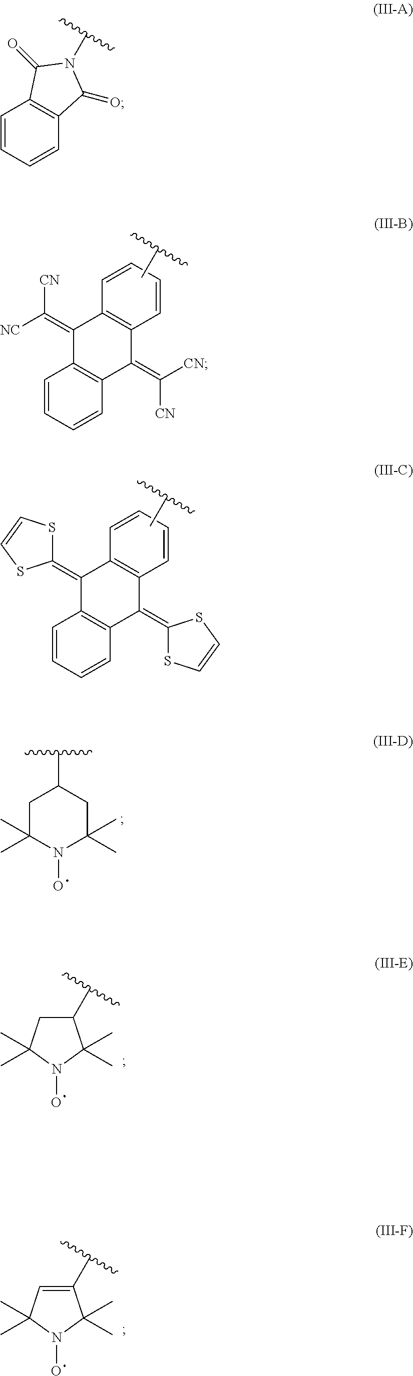

and where, in the structures (III-A), (III-B) and (III-C), at least one aromatic carbon atom may be substituted by a group selected from alkyl group, halogen group, alkoxy group, hydroxyl group. Even more preferably, R^{X} in the structure (III) is selected from the group consisting of compounds of the general formulae (III-A), (III-B), (III-C), (III-D), with (III-D) being the very most preferred.

W in the structure (III) is a repeat unit, and the person skilled in the art is able to select this using his knowledge in the art. The spacer units Sp are connecting units between the redox-active units and the repeat units W that may especially likewise be selected by the person skilled in the art in a routine manner drawing on knowledge in the art.

Preferably, the W radical in the structure (III) is selected from the group consisting of the structures (W1), (W2), (W3):

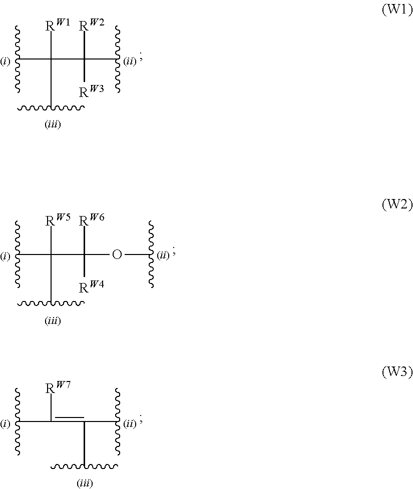

where the bond identified by (i) in a unit of the formula (W1), (W2), (W3) binds in each case to the bond identified by (ii) in the adjacent unit of the formula (W1), (W2) or (W3),
where the bond identified by (iii) in each case identifies the bond to Sp,
and where R^{W1}, R^{W2}, R^{W3}, R^{W4}, R^{W5}, R^{W6}, R^{W7} are independently selected from the group consisting of hydrogen, alkyl group, haloalkyl group, —COOR^{W8} with R^{W8}═H or alkyl,
R^{W1}, R^{W2}, R^{W3}, R^{W4}, R^{W5}, R^{W6}, R^{W7} are preferably independently selected from the group consisting of hydrogen, methyl, —COOH, —COOCH₃,
and where, even more preferably, the W radical in the structure (III) has the structure (W1) in which one of R^{W1}, R^{W2}, R^{W3} is methyl and the other two are hydrogen or all of R^{W1}, R^{W2}, R^{W3} are hydrogen;
and the Sp radical in the structure (III) is selected from the group consisting of direct bond, (Sp1), (Sp2):

[symbol]

-(O)_{pA1}—[C═O]_{pA2}—(O)_{pA3}—B^{Sp}—(O)_{qA1}—[C═O]_{qA2}—(O)_{qA3}- [symbol] (Sp1):

[symbol]

-(O)_{qA4}—[C═O]_{qA5}—(X^{Sp2})_{qA6}- [symbol] with X^{Sp2}═O or NH, especially X^{Sp2}═O,

where pA1, pA2, pA3 are each 0 or 1, excluding the case that “pA2=0, pA1=pA3=1”,
where qA1, qA2, qA3 are each 0 or 1, excluding the case that “qA2=0, qA1=qA3=1”,
where qA4, qA5, qA6 are each 0 or 1, where at least one of qA4, qA5, qA6=1 and where the case that “qA5=0, qA4=qA6=1” is excluded,
where B^{Sp} is selected from the group consisting of
divalent (hetero)aromatic radical, preferably phenyl,
divalent aliphatic radical, which is preferably alkylene, optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester,
and where in the cases in which Sp binds to a non-carbon atom in the R^{X} radical, the structure (Sp1) is subject to the additional condition “qA3=0, qA2=1, qA1=1 or qA3=qA2=qA1=0 or qA3=0, qA2=1, qA1=0”, preferably the condition “qA3=qA2=qA1=0”, and the structure (Sp2) to the additional condition “qA6=0, qA5=1, qA4=1 or qA6=0, qA5=1, qA4=0”,
and where “ [symbol] ” denotes the bond pointing toward R^{X},
and where “ [symbol] ” denotes the bond pointing toward W.

It is pointed out that the condition “where at least one of qA4, qA5, qA6=1”, in respect of Sp2, relates solely to the definition of the respective variables qA4, qA5, qA6 and does not mean that the Sp radical in the structure (III) cannot also be a direct bond.

More preferably, the Sp radical is selected from the group consisting of direct bond, (Sp2) with (Sp2): [symbol] -[C═O]—(O)- [symbol] or [symbol] -[C═O]—(NH)- [symbol] , more preferably from the group consisting of direct bond, (Sp2) with (Sp2): [symbol] -[C═O]—(O)- [symbol] where “ [symbol] ” denotes the bond pointing toward R^{X}, and where “ [symbol] ” denotes the bond pointing toward W.

If the polymer P_{redox1} is a polyimide, it is preferably selected from the group consisting of the structures (IV-1), (IV-2), (IV-3), (IV-4), (IV-5), (IV-6), (IV-7), (IV-8), (IV-9):

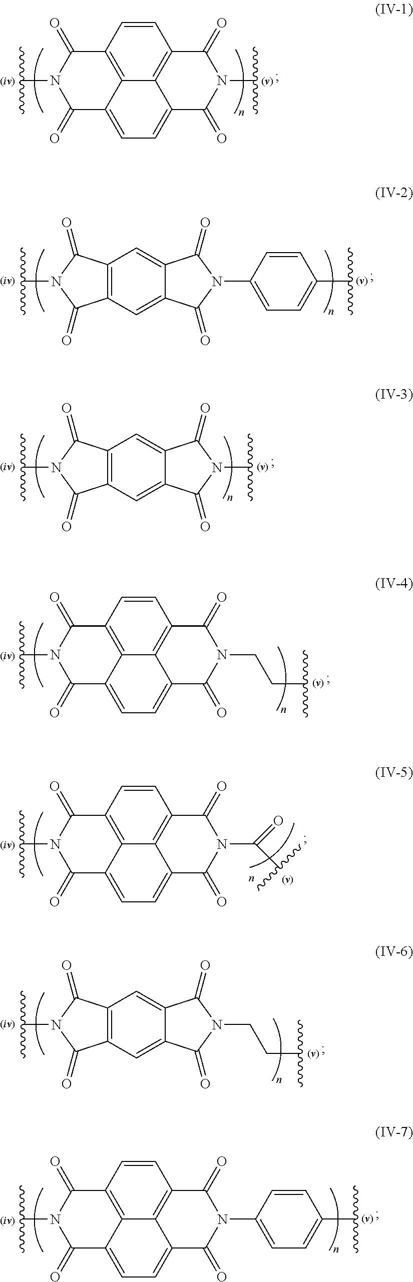

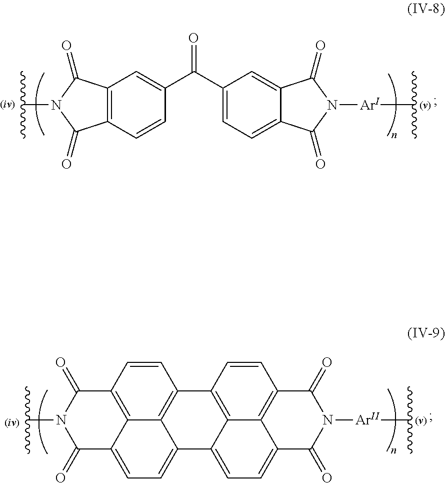

where n is an integer ≥4, preferably an integer ≥10, more preferably an integer ≥100, even more preferably an integer in the range of 1000 to 10⁹, yet more preferably an integer in the range of 2000 to 10 000,
and the bond identified by (iv) in the structures (IV-1), (IV-2), (IV-3), (IV-4), (IV-5), (IV-6), (IV-7), (IV-8), (IV-9) binds in each case to the bond identified by (v),
and where in the structures (IV-1), (IV-2), (IV-3), (IV-4), (IV-5), (IV-6), (IV-7), (IV-8), (IV-9), at least one aromatic carbon atom may be substituted by a group selected from alkyl, halogen, alkoxy, OH, preferably halogen, OH,
and where Ar^{I}, Ar^{II} are each independently a hydrocarbyl group having at least one aryl radical and especially having 6 to 30, preferably 6 to 15, more preferably 6 to 13, carbon atoms.

If the polymer P_{redox1} is a polyimide, this is more preferably selected from the group consisting of the structures (IV-1), (IV-2), (IV-3), (IV-4), (IV-5), (IV-6), (IV-7), (IV-8), (IV-9), where n is an integer ≥4, preferably an integer ≥10, more preferably an integer ≥100, even more preferably an integer in the range of 1000 to 10⁹, yet more preferably an integer in the range of 2000 to 10 000, and the bond identified by (iv) in the structures (IV-1), (IV-2), (IV-3), (IV-4), (IV-5), (IV-6), (IV-7), (IV-8), (IV-9) binds in each case to the bond identified by (v),

and where Ar^{I}, Ar^{II} are each independently a hydrocarbyl group having at least one aryl radical and especially having 6 to 30, preferably 6 to 15, more preferably 6 to 13, carbon atoms.

More preferably, the polymer P_{redox1} comprises t repeat units joined to one another, selected from the group consisting of the structures P1, P2, P3, P4, P5, P6:

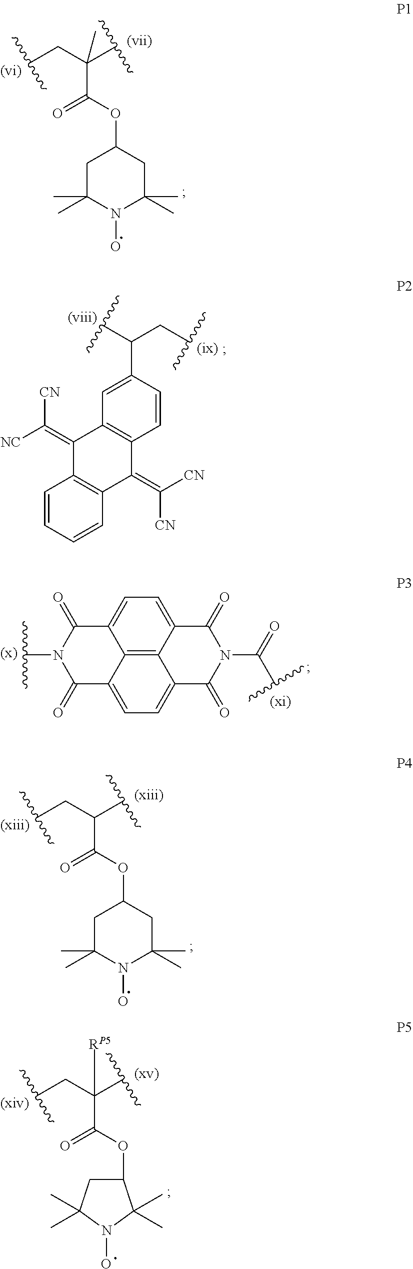

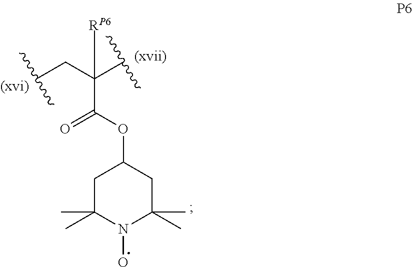

where t is an integer ≥4, preferably an integer ≥10, more preferably an integer ≥100, even more preferably an integer in the range of 1000 to 10⁹, yet more preferably an integer in the range of 2000 to 10 000,
where R^{P5}, R^{P6} are each independently selected from the group consisting of hydrogen, methyl, and are especially each hydrogen,
and the bond identified by (vi) in a unit of the formula P1 binds to the bond identified by (vii) in the adjacent unit of the formula P1,
and the bond identified by (viii) in a unit of the formula P2 binds to the bond identified by (ix) in the adjacent unit of the formula P2,
and the bond identified by (x) in a unit of the formula P3 binds to the bond identified by (xi) in the adjacent unit of the formula P3,
and the bond identified by (xii) in a unit of the formula P4 binds to the bond identified by (xiii) in the adjacent unit of the formula P4,
and the bond identified by (xiv) in a unit of the formula P5 binds to the bond identified by (xv) in the adjacent unit of the formula P5,
and the bond identified by (xvi) in a unit of the formula P6 binds to the bond identified by (xvii) in the adjacent unit of the formula P6.

In a preferred embodiment of the process according to the invention for producing a charge storage unit, the polymer P1 is included as polymer P_{redox1} in the electrode E₁ used with preference as cathode, and at least one of the polymers P2, P3, preferably P2, is included as polymer P_{redox2} in the electrode E₂ used in particular as anode.

In a preferred embodiment of the process according to the invention for producing a charge storage unit, the polymer P4 is included as polymer P_{redox1} in the electrode E₁ used with preference as cathode, and at least one of the polymers P2, P3, preferably P2, is included as polymer P_{redox2} in the electrode E₂ used in particular as anode.

In a preferred embodiment of the process according to the invention for producing a charge storage unit, the polymer P5 with R^{P5}═H is included as polymer P_{redox1} in the electrode E₁ used with preference as cathode, and at least one of the polymers P2, P3, preferably P2, is included as polymer P_{redox2} in the electrode E₂ used in particular as anode.

In a preferred embodiment of the process according to the invention for producing a charge storage unit, the polymer P5 with R^{P5}═CH₃ is included as polymer P_{redox1} in the electrode E₁ used with preference as cathode, and at least one of the polymers P2, P3, preferably P2, is included as polymer P_{redox2} in the electrode E₂ used in particular as anode.

In a preferred embodiment of the process according to the invention for producing a charge storage unit, the polymer P6 with R^{P6}═H is included as polymer P_{redox1} in the electrode E₁ used with preference as cathode, and at least one of the polymers P2, P3, preferably P2, is included as polymer P_{redox2} in the electrode E₂ used in particular as anode.

In a preferred embodiment of the process according to the invention for producing a charge storage unit, the polymer P6 with R^{P6}═CH₃ is included as polymer P_{redox1} in the electrode E₁ used with preference as cathode, and at least one of the polymers P2, P3, preferably P2, is included as polymer P_{redox2} in the electrode E₂ used in particular as anode.

The end groups of the first repeat unit of the polymer P_{redox} which is present for these on the bonds defined by “(i)” in the chemical structure (III), and is present for these on the bonds defined by “(vi)” in the chemical structure P1, and is present for these on the bonds defined by “(viii)” in the chemical structure P2, and is present for these on the bonds defined by “(x)” in the chemical structure P3, and is present for these on the bonds defined by “(xii)” in the chemical structure P4, and is present for these on the bonds defined by “(xiv)” in the chemical structure P5, and is present for these on the bonds defined by “(xvi)” in the chemical structure P6, and is present for these on the bonds defined in each case by “(iv)” in the chemical structures (IV-1), (IV-2), (IV-3), (IV-4), (IV-5), (IV-6), (IV-7), (IV-8), (IV-9),

and the end groups of the last repeat unit of the polymer P_{redox} according to the invention which is present for these on the bonds defined by “(ii)” in the chemical structure (III), and is present for these on the bonds defined by “(vii)” in the chemical structure P1, and is present for these on the bonds defined by “(ix)” in the chemical structure P2, and is present for these on the bonds defined by “(xi)” in the chemical structure P3, and is present for these on the bonds defined by “(xiii)” in the chemical structure P4, and is present for these on the bonds defined by “(xv)” in the chemical structure P5, and is present for these on the bonds defined by “(xvii)” in the chemical structure P6, and is present for these on the bonds defined in each case by “(v)” in the chemical structures (IV-1), (IV-2), (IV-3), (IV-4), (IV-5), (IV-6), (IV-7), (IV-8), (IV-9),
are not particularly restricted and are apparent from the polymerization method used in the preparation method for the polymer P_{redox1}. Thus, they may be termination fragments of an initiator or of a repeat unit. Preferably, these end groups are selected from hydrogen, halogen, hydroxyl, unsubstituted aliphatic radical or aliphatic radical substituted by —CN, —OH, halogen (which may especially be an unsubstituted or correspondingly substituted alkyl group), (hetero)aromatic radical, which is preferably a phenyl radical, benzyl radical or α-hydroxybenzyl.

### 1.1.2.2 Conductivity Additive L₁

### 1.1.2.2.1 Preferred Conductivity Additive L₁

The at least one conductivity additive L₁ which is included in the mixture M₁ which is used in step (a) of the process according to the first aspect of the invention is at least one electrically conductive material, especially selected from the group consisting of carbon materials, electrically conductive polymers, metals, semimetals, (semi)metal compounds, preferably selected from carbon materials, electrically conductive polymers.

According to the invention, “(semi)metals” are selected from the group consisting of metals, semimetals, and are preferably metals.

Metals are especially selected from the group consisting of zinc, iron, copper, silver, gold, chromium, nickel, tin, indium.

Semimetals are especially selected from silicon, germanium, gallium, arsenic, antimony, selenium, tellurium, polonium.

The conductivity additive L₁ is more preferably a carbon material. Carbon materials are especially selected from the group consisting of carbon fibres, carbon nanotubes, graphite, graphene, carbon black, fullerene.

Electrically conductive polymers are especially selected from the group consisting of polypyrroles, polyanilines, polyphenylenes, polypyrenes, polyazulenes, polynaphthylenes, polycarbazoles, polyindoles, polyazepines, polyphenylene sulfides, polythiophenes, polyacetylenes, poly(3,4-ethylenedioxythiophene) polystyrenesulfonate (=PEDOT:PSS), polyarcenes, poly-(p-phenylenevinylenes).

### 1.1.2.2.2 Preferred Amount of the Conductivity Additive L₁

The amount of the conductivity additive L₁ included in the mixture M₁ in step (a) of the process according to the first aspect of the invention is not subject to any further restriction. However, it is preferable that the total weight of all conductivity additives L₁ included in the mixture M₁, based on the total weight of the redox polymers P_{redox1} included in the mixture M₁, is in the range of 0.1% to 1000% by weight, preferably in the range of 10% to 500% by weight, more preferably in the range of 30% to 100% by weight, yet more preferably in the range of 40% to 80% by weight, even more preferably in the range of 50% by weight to 60% by weight, most preferably 58.3% by weight.

### 1.1.2.3 Solvent Solv₁

The at least one solvent Solv₁ included in the mixture M₁ is especially a solvent having a high boiling point, preferably selected from the group consisting of N-methyl-2-pyrrolidone, water, dimethyl sulfoxide, ethylene carbonate, propylene carbonate, dimethyl carbonate, methyl ethyl carbonate, γ-butyrolactone, tetrahydrofuran, dioxolane, sulfolane, N,N′-dimethylformamide, N,N-dimethylacetamide, more preferably dimethyl sulfoxide or water, even more preferably water.

More particularly, the mixture M₁ comprises a sufficient amount of solvent Solv₁ that the concentration of the organic redox-active polymer P_{redox1} in the mixture M₁ is between 1 and 100 mg/ml, preferably between 5 and 50 mg/ml.

### 1.1.2.4 Binder Additive B₁

More particularly, the mixture M₁ also comprises at least one binder additive B₁.

Binder additives B₁ are familiar to the person skilled in the art as materials having binding properties. Preference is given to polymers selected from the group consisting of poly(vinylidene fluoride-co-hexafluoropropylene) (PVdF-HFP), polytetrafluoroethylene, polyvinylidene fluoride, polyhexafluoropropylene, polyvinyl chloride, polycarbonate, polystyrene, polyacrylate, polymethacrylate, polysulfone, cellulose derivatives, polyurethane, and the binder additive more preferably comprises cellulose derivatives, e.g. sodium carboxymethylcellulose or PVdF-HFP or polyvinylidene fluoride.

In the cases in which the mixture M₁ comprises at least one binder additive B₁, the amount of all binder additives B₁ included in the mixture M₁ in step (a) of the process according to the invention in the first aspect of the invention is not subject to any further restriction.

However, it is preferable in these cases that the total weight of all binder additives B₁ included in the mixture M₁, based on the total weight of the redox polymer P_{redox1} included in the mixture M₁, is in the range of 0.001% to 100% by weight, more preferably in the range of 0.1% to 90% by weight, yet more preferably in the range of 3% to 70% by weight, still more preferably in the range of 5% to 50% by weight, even more preferably in the range of 7.5% by weight to 20% by weight, and is most preferably 16.6% by weight.

### 1.1.2.5 Ionic Liquid IL₁

More particularly, the mixture M₁ also comprises at least one ionic liquid IL₁.

The at least one ionic liquid IL₁ included in the mixture M₁ is not particularly restricted and is described, for example, in WO 2004/016631 A1, WO 2006/134015 A1, US 2011/0247494 A1 or US 2008/0251759 A1.

More particularly, the at least one ionic liquid IL₁ included in the mixture M₁ in step (a) of the process according to the invention has the structure Q⁺A⁻.

1.1.2.5.1 Preferred Cation Q⁺ of IL₁
Q⁺ therein is a cation selected from the group consisting of the following structures (Q1), (Q2), (Q3), (Q4), (Q5):

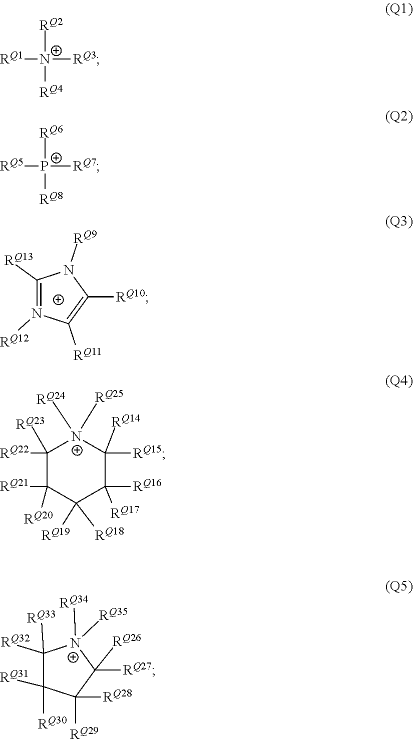

where R^{Q1}, R^{Q2}, R^{Q3}, R^{Q4}, R^{Q5}, R^{Q6}, R^{Q7}, R^{Q8} are each independently selected from the group consisting of alkyl group, haloalkyl group, cycloalkyl group,
where R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, R^{Q35} are each independently selected from the group consisting of hydrogen, alkyl group, (poly)ether group, haloalkyl group, cycloalkyl group.

Preferably, Q⁺ is a cation selected from the group consisting of the structures (Q1), (Q2), (Q3), (Q4), (Q5) where R^{Q1}, R^{Q2}, R^{Q3}, R^{Q4}, R^{Q5}, R^{Q6}, R^{Q7}, R^{Q8} are each independently selected from the group consisting of alkyl group having 6 to 40, more preferably 10 to 30, carbon atoms, cycloalkyl group having 6 to 40, more preferably 10 to 30, carbon atoms, where R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, R^{Q35} are each independently selected from the group consisting of hydrogen, alkyl group having 1 to 25, preferably 1 to 10, carbon atoms, (poly)ether group having 1 to 25, preferably 1 to 10, carbon atoms.

More preferably, Q⁺ is a cation selected from the group consisting of the structures (Q1), (Q3) where R^{Q1}, R^{Q2}, R^{Q3}, R^{Q4} are each independently selected from the group consisting of alkyl group having 6 to 30, preferably 10 to 25, carbon atoms, where R^{Q9}, R^{Q10}, R^{Q11}, R^{Q12}, R^{Q13} are each independently selected from the group consisting of hydrogen, alkyl group having 1 to 25, preferably 1 to 10, carbon atoms and R^{Q10}, R^{Q11}, R^{Q13} are more preferably each hydrogen and R^{Q9}, R^{Q12} are each independently an alkyl radical having 1 to 6 carbon atoms.

Even more preferably, Q⁺ is a cation of the structure (Q3) where R^{Q10}, R^{Q11}, R^{Q13} are each hydrogen and R^{Q9} is selected from the group consisting of methyl, ethyl, n-propyl, iso-propyl, n-butyl, sec-butyl, tert-butyl, and R^{Q12} is selected from the group consisting of methyl, ethyl, n-propyl, iso-propyl, n-butyl, sec-butyl, tert-butyl.

Even more preferably, Q⁺ is a cation of the structure (Q3) where R^{Q10}, R^{Q11}, R^{Q13} are each hydrogen and R^{Q9} is selected from the group consisting of methyl, ethyl, n-butyl, preferably selected from the group consisting of ethyl, n-butyl, where R^{Q9} is most preferably ethyl, and R^{Q12} is selected from the group consisting of methyl, ethyl, where R^{Q12} is most preferably methyl.

Particularly preferred as Q⁺ is the 1-ethyl-3-methylimidazolium cation.

1.1.2.5.2 Preferred Anion A⁻ of IL₁

In the aforementioned formula Q⁺A⁻, A⁻ is an anion, especially selected from the group consisting of phosphate, phosphonate, alkylphosphonate, monoalkylphosphate, dialkylphosphate, bis[trifluoromethanesulfonyl]imide, alkylsulfonate, haloalkylsulfonate, alkylsulfate, haloalkylsulfate, bis[fluorosulfonyl]imide, halide, dicyanamide, hexafluorophosphate, sulfate, tetrafluoroborate, trifluoromethanesulfonate, perchlorate, hydrogensulfate, haloalkylcarboxylate, alkylcarboxylate, formate, bisoxalatoborate, tetrachloroaluminate, dihydrogenphosphate, monoalkylhydrogenphosphate, nitrate.

In the aforementioned formula Q⁺A⁻, A⁻ is preferably selected from the group consisting of phosphate, phosphonate, alkylphosphonate, monoalkylphosphate, dialkylphosphate, bis[trifluoromethanesulfonyl]imide, alkylsulfonate, alkylsulfate, bis[fluorosulfonyl]imide, halide, dicyanamide, hexafluorophosphate, sulfate, tetrafluoroborate, trifluoromethanesulfonate, perchlorate, hydrogensulfate, alkylcarboxylate, formate, bisoxalatoborate, tetrachloroaluminate, dihydrogenphosphate, monoalkylhydrogenphosphate, nitrate, where the alkyl groups in alkylphosphonate, monoalkylphosphate, dialkylphosphate, alkylsulfonate, alkylsulfate, alkylcarboxylate, monoalkylhydrogenphosphate each have 1 to 10, preferably 1 to 6, more preferably 1 to 4, carbon atoms.

In the aforementioned formula Q⁺A⁻, A⁻ is more preferably selected from the group consisting of dialkylphosphate, bis[trifluoromethanesulfonyl]imide, alkylsulfonate, bis[fluorosulfonyl]imide, chloride, dicyanamide, hexafluorophosphate, tetrafluoroborate, trifluoromethanesulfonate, perchlorate, acetate, propionate, formate, tetrachloroaluminate, monoalkylhydrogenphosphate, nitrate, where the alkyl groups in dialkylphosphate, alkylsulfonate, monoalkylhydrogenphosphate each have 1 to 10, preferably 1 to 6, more preferably 1 to 4, carbon atoms.

In the aforementioned formula Q⁺A⁻, A⁻ is even more preferably selected from the group consisting of diethylphosphate, bis[trifluoromethanesulfonyl]imide, methanesulfonate, bis[fluorosulfonyl]imide, chloride, dicyanamide, hexafluorophosphate, tetrafluoroborate, trifluoromethanesulfonate, perchlorate, acetate, propionate, formate, tetrachloroaluminate, monoethylhydrogenphosphate, nitrate.

In the aforementioned formula Q⁺A⁻, A⁻ is even more preferably selected from the group consisting of trifluoromethanesulfonate, bis[trifluoromethanesulfonyl]imide, diethylphosphate, dicyanamide, most preferably from the group consisting of trifluoromethanesulfonate, bis[trifluoromethanesulfonyl]imide, and is at the very most preferably bis[trifluoromethanesulfonyl]imide.

### 1.1.2.5.3 Amount of IL₁ Used

In the cases in which the mixture M₁ comprises at least one ionic liquid IL₁, the amount of the ionic liquid IL₁ included in the mixture M₁ in step (a) of the process according to the invention in the first aspect of the invention is not subject to any further restriction.

In the cases in which the mixture M₁ comprises at least one ionic liquid IL₁, however, it is preferable that the total molar amount of all ionic liquids IL₁ included in the mixture M₁ in step (a) of the process according to the invention, based on the total molar amount of all organic redox-active polymers P_{redox1} included in the mixture M₁, is in the range from 0.1% to 1000% by weight, more preferably in the range of 1% to 500% by weight, yet more preferably in the range of 5% to 200% by weight, still more preferably in the range of 40 to 160% by weight, even more preferably in the range of 80% to 120% by weight, and is most preferably 100% by weight.

1.1.3 Applying the Mixture M₁ to the Substrate S₁

The mixture M₁ can be applied to the substrate S₁ by methods familiar to the person skilled in the art.

Bar coating, slot die coating, screen printing or stencil printing are familiar to the person skilled in the art and are preferably used for the purpose.

### 1.2 Step (b) of the Process According to the Invention

After step (a) of the process according to the invention, the solvent Solv₁ is at least partly removed in step (b). The removal from the mixture M₁ that has been applied to the substrate S₁ is effected by methods known to the person skilled in the art, for example by drying under air, in the presence of inert gas (preferably nitrogen or argon) or under reduced pressure, in each case especially at elevated temperature.

On conclusion of step (b), an electrode E₁ applied to the substrate S₁ is obtained.

### 1.3 Step (c) of the Process According to the Invention

In step (c) of the process according to the invention, a polymer electrolyte Pₑₗ is applied to the electrode E₁ obtained after step (b) of the process according to the invention.

### 1.3.1 Polymer Electrolyte Pₑₗ

Such polymer electrolytes Pₑₗ are familiar to the person skilled in the art and are described, for example, in the prior art documents that follow.

W. Huang, Z. Zhu, L. Wang, S. Wang, H. Li, Z. Tao, J. Shi, L. Guan, J. Chen, Angew. Chem. Int. Ed. 2013, 52, 9162-9166 describe a battery including a polymer electrolyte composed of poly(methacrylate) and polyethylene glycol.

J. Kim, A. Matic, J. Ahn, P. Jacobsson, C. Song, RSC Adv. 2012, 2, 10394-10399 describe an ionic liquid-based microporous polymer electrolyte hosted in poly(vinylidene fluoride-co-hexafluoropropylene) (PVdF-HFP).

Z. Zhu, M. Hong, D. Guo, J. Shi, Z. Tao, J. Chen, J. Am. Chem. Soc. 2014, 136, 16461-16464 describe a polymer electrolyte composed of poly(methacrylate) and polyethylene glycol in combination with SiO₂.

M. Lécuyer, J. Gaubicher, A. Barrés, F. Dolhem, M. Deschamps, D. Guyomard, P. Poizot, Electrochem. Commun. 2015, 55, 22-25 and W. Li, L. Chen, Y. Sun, C. Wang, Y. Wang, Y. Xia, Solid State Ionics 2017, 300, 114-119 describe polyethylene oxide as polymer electrolyte in a lithium battery.

A corresponding use of a matrix composed of PVdF-HFP with poly(2,2,6,6-tetramethylpiperidinyloxy methacrylate) (PTMA) as polymeric linear active material is described by J. Kim, A. Matic, J. Ahn, P. Jacobsson, RSC Adv. 2012, 2, 9795-9797.

Use of similar polymer electrolytes for increasing the safety of organolithium batteries is described by J. Kim, G. Cheruvally, J. Choi, J. Ahn, D. Choi, C. Eui Song, J. Electrochem. Soc. 2007, 154, A839-A843.

More particularly, the polymer electrolyte Pₑₗ is obtained by polymerizing a mixture Mₚₑₗ comprising at least one compound selected from compounds of the formula (I), and compounds of the formula (II):

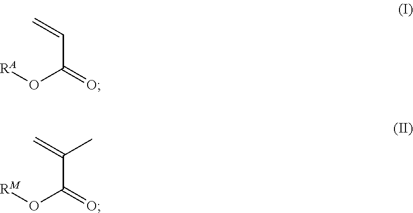

where R^{A}, R^{M} are independently selected from the group consisting of hydrogen, alkyl group, (poly)ether group, aryl group, aralkyl group, alkaryl group, haloalkyl group, and wherein the mixture Mₚₑₗ optionally comprises at least one ionic liquid IL₃.

Preferably, the polymerizing of the mixture Mₚₑₗ is conducted on the electrode E₁ or the mixture Mₚₑₗ is polymerized and the polymer electrolyte Pₑₗ thus obtained is then applied to the electrode E₁ by methods familiar to the person skilled in the art.

### 1.3.2 Polymerizing a Mixture Mₚₑₗ

By polymerizing the mixture Mₚₑₗ comprising at least one compound selected from compounds of the formula (I), and compounds of the formula (II):

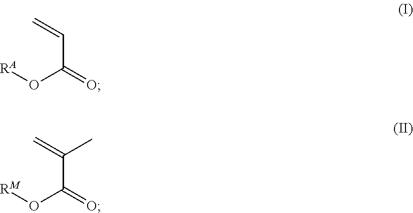

where R^{A}, R^{M} are independently selected from the group consisting of hydrogen, alkyl group, (poly)ether group, aryl group, aralkyl group, alkaryl group, haloalkyl group,
and optionally at least one ionic liquid IL₃, the polymer electrolyte Pₑₗ is obtained.

R^{A}, R^{M} are independently selected from the group consisting of hydrogen, alkyl group, (poly)ether group, aryl group, aralkyl group, alkaryl group, fluoroalkyl group.

Preferably, R^{A}, R^{M} are independently selected from hydrogen, alkyl group, polyether group, alkaryl group, even more preferably from hydrogen, benzyl, —(CH₂CH₂O)ᵥR^{v}, even more preferably independently from benzyl, —(CH₂CH₂O)ᵥR^{v}, where v is an integer ≥3 and v is especially an integer in the range of 3 to 50, more preferably in the range of 5 to 15, even more preferably in the range of 8 to 9; and R^{v} is selected from the group consisting of hydrogen, alkyl group, which is preferably methyl.

This involves polymerizing the compounds of the formula (I) and/or (II) with one another, while any IL₃ included in the mixture Mₚₑₗ does not take part in the polymerization reaction but, when it is used in the mixture Mₚₑₗ, is incorporated in the polymer electrolyte Pₑₗ obtained.

The compound of the formula (I) is an acrylate-based compound (“acrylate compound”). The compound of the formula (II) is a methacrylate-based compound (“methacrylate compound”).

Processes for polymerizing these and corresponding monomers are known to those skilled in the art and are described, for example, in K.-H. Choi, J. Yoo, C. K. Lee, S.-Y. Lee, Energy Environ. Sci. 2016, 9, 2812-2821. For example, the production of the polymer electrolyte Pₑₗ takes place in a one-stage process via a polymerization, optionally in the presence of the ionic liquid IL₃.

It is preferable that the mixture Mₚₑₗ comprises a mixture of compounds of formula (I) and compounds of the formula (II). In that case, in particular, the molar ratio of all compounds of formula (I) included in the mixture Mₚₑₗ to all compounds of the formula (II) included in the mixture Mₚₑₗ is in the range of 99:1 to 1:99, preferably in the range of 49:1 to 1:19, more preferably in the range of 97:3 to 1:9, even more preferably in the range of 24:1 to 1:4, still more preferably in the range of 49:1 to 1:3, yet more preferably still in the range of 49:1 to 1:1, and most preferably in the range of 9:1 to 4:1, where the ratio of 9:1 is the very most preferred.

This is because it has been found that, surprisingly, organic batteries comprising a polymer electrolyte Pₑₗ that has been prepared from a mixture Mₚₑₗ comprising compounds of formula (I) and compounds of the formula (II) have high capacities.

For production of the polymer electrolyte Pₑₗ, for example as electrolyte film, the mixture Mₚₑₗ is first mixed as a paste from all components present and especially applied to the electrode E₁. After initiation of the polymerization, the mechanically stable and elastic electrolyte film is then formed.

The properties of the paste, in particular the viscosity, can be further optimized here in order to make it employable for printing processes, for example stencil printing or screen printing.

The method described enables performance of the polymerization even in the presence of all components of the electrolyte film, and so no subsequent swelling with electrolyte liquid or other downstream processes such as evaporating of a solvent are required.

After performance of step (c) of the process according to the invention, a polymer electrolyte Pₑₗ is accordingly obtained on the electrode E₁.

### 1.4 Step (d) of the Process According to the Invention

In step d) of the process according to the invention, a mixture M₂ comprising at least one organic redox-active polymer P_{redox2}, at least one conductivity additive L₂, at least one solvent Solv₂, optionally at least one binder additive B₂ and optionally at least one ionic liquid IL₂ is applied to the polymer electrolyte Pₑₗ.

### 1.4.1 Mixture M₂

The mixture M₂ used in step (d) of the process according to the invention comprises at least one organic redox-active polymer P_{redox2}, at least one conductivity additive L₂, at least one solvent Solv₂, optionally at least one binder additive B₂ and optionally at least one ionic liquid IL₂.

The mixture M₂ is especially an electrode slurry, especially a solution or suspension, with which the constituents of the electrode E₂ obtained at a later stage are applied to the polymer electrolyte Pₑₗ.

### 1.4.2 Organic Redox-Active Polymer P_{redox2}

The polymers usable as organic redox-active polymer P_{redox2} that are included in the mixture M₂ are known to those skilled in the art and are described, for example, in US 2016/0233509 A1, US 2017/0114162 A1, US 2017/0179525 A1, US 2018/0108911 A1, US 2018/0102541 A1, WO 2017/207325 A1, WO 2015/032951 A1. An overview of further usable organic redox-active polymers is given by the article S. Muench, A. Wild, C. Friebe, B. Häupler, T. Janoschka, U.S. Schubert, Chem. Rev. 2016, 116, 9438-9484.

The polymers P_{redox2} can be prepared by the methods described under point 1.1.2.1.

The organic redox-active polymer P_{redox2} is preferably selected from the group consisting of polyimides and polymers comprising m units of the general formula (III):

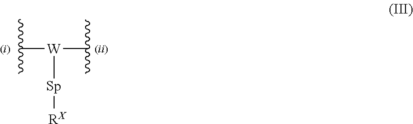

where m is an integer ≥4, preferably an integer ≥10, more preferably an integer ≥100, even more preferably an integer in the range of 1000 to 10⁹, yet more preferably an integer in the range of 2000 to 10 000, W is a repeat unit, Sp is an organic spacer and R^{X} is an organic redox-active group, where the bond identified by (i) in a unit of the formula (III) binds to the bond identified by (ii) in the adjacent unit of the formula (III).

R^{X} in the structure (III) is preferably selected from the group consisting of compounds of the general formulae (III-A), (III-B), (III-C), (III-D), (III-E), (III-F) where

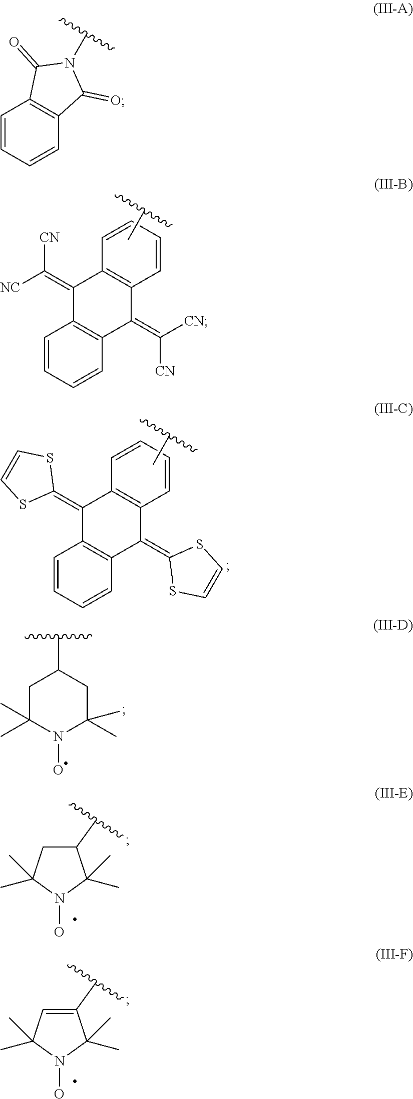

and where, in the structures (III-A), (III-B) and (III-C), at least one aromatic carbon atom may be substituted by a group selected from alkyl group, halogen group, alkoxy group, hydroxyl group. Even more preferably, R^{X} in the structure (III) is selected from the group consisting of compounds of the general formulae (III-A), (III-B), (III-C), (III-D), with (III-B), (III-C) being more preferred and (III-B) being the very most preferred.
W in the structure (III) is a repeat unit, and the person skilled in the art is able to select this using his knowledge in the art. The spacer units Sp are connecting units between the redox-active units and the repeat units W that may especially likewise be selected by the person skilled in the art in a routine manner drawing on knowledge in the art.

Preferably, the W radical in the structure (III) is selected from the group consisting of the structures (W1), (W2), (W3):

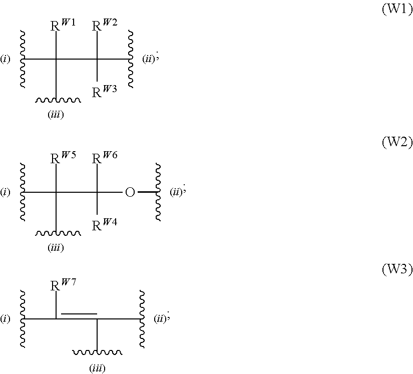

where the bond identified by (i) in a unit of the formula (W1), (W2), (W3) binds in each case to the bond identified by (ii) in the adjacent unit of the formula (W1), (W2) or (W3),
where the bond identified by (iii) in each case identifies the bond to Sp,
and where R^{W1}, R^{W2}, R^{W3}, R^{W4}, R^{W5}, R^{W6}, R^{W7} are independently selected from the group consisting of hydrogen, alkyl group, haloalkyl group, —COOR^{W8} with R^{W8}═H or alkyl,
R^{W1}, R^{W2}, R^{W3}, R^{W4}, R^{W5}, R^{W6}, R^{W7} are preferably independently selected from the group consisting of hydrogen, methyl, —COOH, —COOCH₃,
and where, even more preferably, the W radical in the structure (III) has the structure (W1) in which one of R^{W1}, R^{W2}, R^{W3} is methyl and the other two are hydrogen or all of R^{W1}, R^{W2}, R^{W3} are hydrogen;
and the Sp radical in the structure (III) is selected from the group consisting of direct bond, (Sp1), (Sp2):

[symbol]

-(O)_{pA1}—[C═O]_{pA2}—(O)_{pA3}—B^{Sp}—(O)_{qA1}—[C═O]_{qA2}—(O)_{qA3}- [symbol] , (Sp1):

[symbol]

-(O)_{qA4}—[C═O]_{qA5}—(X^{Sp})_{qA6}- [symbol] with X^{Sp2}═O or NH, especially X^{Sp2}—O, (Sp2):

where pA1, pA2, pA3 are each 0 or 1, excluding the case that “pA2=0, pA1=pA3=1”,
where qA1, qA2, qA3 are each 0 or 1, excluding the case that “qA2=0, qA1=qA3=1”,
where qA4, qA5, qA6 are each 0 or 1, where at least one of qA4, qA5, qA6=1 and where the case that “qA5=0, qA4=qA6=1” is excluded,
where B^{Sp} is selected from the group consisting of
divalent (hetero)aromatic radical, preferably phenyl,
divalent aliphatic radical, which is preferably alkylene, optionally substituted by at least one group selected from nitro group, —NH₂, —CN, —SH, —OH, halogen and optionally having at least one group selected from ether, thioether, amino ether, carbonyl group, carboxylic ester, carboxamide group, sulfonic ester, phosphoric ester,
and where in the cases in which Sp binds to a non-carbon atom in the R^{X} radical, the structure (Sp1) is subject to the additional condition “qA3=0, qA2=1, qA1=1 or qA3=qA2=qA1=0 or qA3=0, qA2=1, qA1=0”, preferably the condition “qA3=qA2=qA1=0”, and the structure (Sp2) to the additional condition “qA6=0, qA5=1, qA4=1 or qA6=0, qA5=1, qA4=0”,
and where “ [symbol] ” denotes the bond pointing toward R^{X},
and where “ [symbol] ” denotes the bond pointing toward W.

It is pointed out that the condition “where at least one of qA4, qA5, qA6=1”, in respect of Sp2, relates solely to the definition of the respective variables qA4, qA5, qA6 and does not mean that the Sp radical in the structure (III) cannot also be a direct bond.

More preferably, the Sp radical is selected from the group consisting of direct bond, (Sp2) with (Sp2): [symbol] -[C═O]—(O)- [symbol] or [symbol] -[C═O]—(NH)- [symbol] , more preferably from the group consisting of direct bond, (Sp2) with (Sp2): [symbol] -[C═O]—(O)- [symbol] where “ [symbol] ” denotes the bond pointing toward R^{X}, and where “ [symbol] ” denotes the bond pointing toward W.

If the polymer P_{redox2} is a polyimide, it is preferably selected from the group consisting of the structures (IV-1), (IV-2), (IV-3), (IV-4), (IV-5), (IV-6), (IV-7), (IV-8), (IV-9):

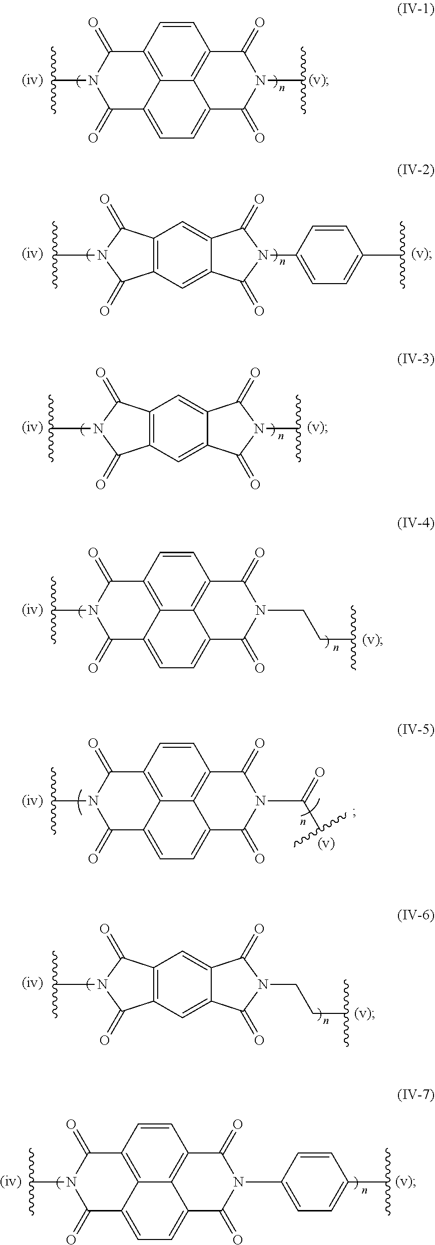

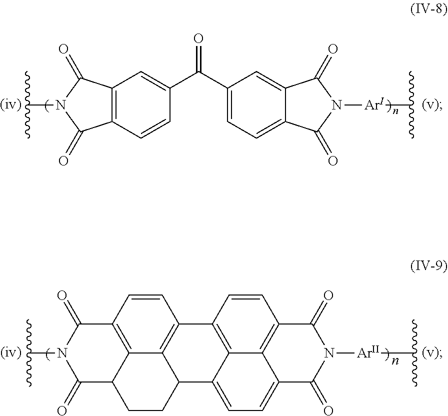

where n is an integer ≥4, preferably an integer ≥10, more preferably an integer ≥100, even more preferably an integer in the range of 1000 to 10⁹, yet more preferably an integer in the range of 2000 to 10 000,
and the bond identified by (iv) in the structures (IV-1), (IV-2), (IV-3), (IV-4), (IV-5), (IV-6), (IV-7), (IV-8), (IV-9) binds in each case to the bond identified by (v),
and where Ar^{I}, Ar^{II} are each independently a hydrocarbyl group having at least one aryl radical and especially having 6 to 30, preferably 6 to 15, more preferably 6 to 13, carbon atoms.
and where in the structures (IV-1), (IV-2), (IV-3), (IV-4), (IV-5), (IV-6), (IV-7), (IV-8), (IV-9), at least one aromatic carbon atom may be substituted by a group selected from alkyl, halogen, alkoxy, OH, preferably halogen, OH,

If the polymer P_{redox2} is a polyimide, this is more preferably selected from the group consisting of the structures (IV-1), (IV-2), (IV-3), (IV-4), (IV-5), (IV-6), (IV-7), (IV-8), (IV-9), where n is an integer ≥4, preferably an integer ≥10, more preferably an integer ≥100, even more preferably an integer in the range of 1000 to 10⁹, yet more preferably an integer in the range of 2000 to 10 000, and the bond identified by (iv) in the structures (IV-1), (IV-2), (IV-3), (IV-4), (IV-5), (IV-6), (IV-7), (IV-8), (IV-9) binds in each case to the bond identified by (v),

and where Ar^{I}, Ar^{II} are each independently a hydrocarbyl group having at least one aryl radical and especially having 6 to 30, preferably 6 to 15, more preferably 6 to 13, carbon atoms.

More preferably, the polymer P_{redox2} comprises t repeat units joined to one another, selected from the group consisting of the structures P1, P2, P3, P4, P5, P6:

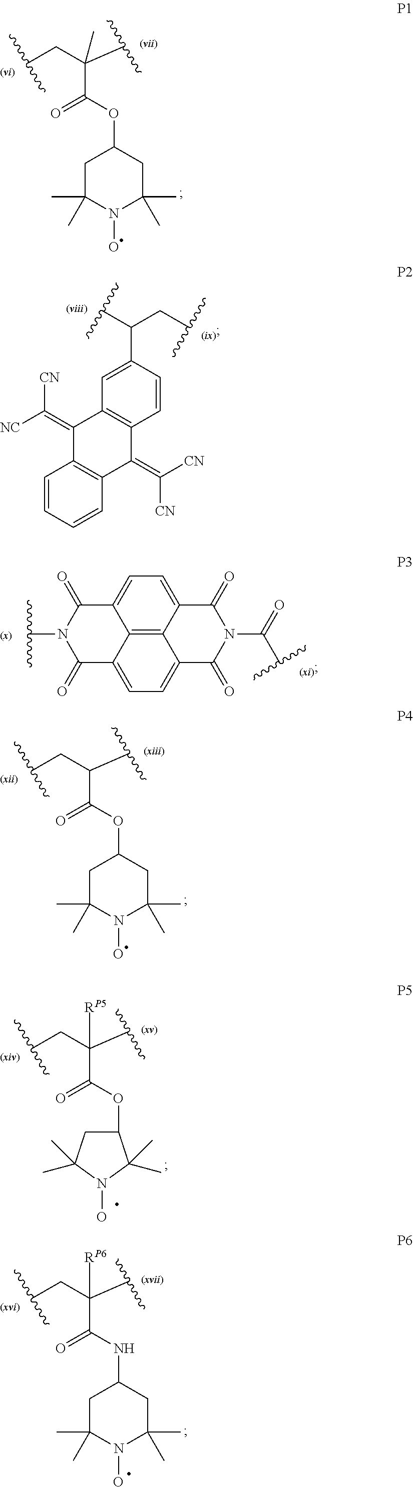

where t is an integer ≥4, preferably an integer ≥10, more preferably an integer ≥100, even more preferably an integer in the range of 1000 to 10⁹, yet more preferably an integer in the range of 2000 to 10 000,
where R^{P5}, R^{P6} are each independently selected from the group consisting of hydrogen, methyl, and are especially each hydrogen,
and the bond identified by (vi) in a unit of the formula P1 binds to the bond identified by (vii) in the adjacent unit of the formula P1,
and the bond identified by (viii) in a unit of the formula P2 binds to the bond identified by (ix) in the adjacent unit of the formula P2,
and the bond identified by (x) in a unit of the formula P3 binds to the bond identified by (xi) in the adjacent unit of the formula P3,
and the bond identified by (xii) in a unit of the formula P4 binds to the bond identified by (xiii) in the adjacent unit of the formula P4,
and the bond identified by (xiv) in a unit of the formula P5 binds to the bond identified by (xv) in the adjacent unit of the formula P5,
and the bond identified by (xvi) in a unit of the formula P6 binds to the bond identified by (xvii) in the adjacent unit of the formula P6.

The end groups of the first repeat unit of the polymer P_{redox2} which is present for these on the bonds defined by “(i)” in the chemical structure (III), and is present for these on the bonds defined by “(vi)” in the chemical structure P1, and is present for these on the bonds defined by “(viii)” in the chemical structure P2, and is present for these on the bonds defined by “(x)” in the chemical structure P3, and is present for these on the bonds defined by “(xii)” in the chemical structure P4, and is present for these on the bonds defined by “(xiv)” in the chemical structure P5, and is present for these on the bonds defined by “(xvi)” in the chemical structure P6, and is present for these on the bonds defined in each case by “(iv)” in the chemical structures (IV-1), (IV-2), (IV-3), (IV-4), (IV-5), (IV-6), (IV-7), (IV-8), (IV-9),

and the end groups of the last repeat unit of the polymer P_{redox2} according to the invention which is present for these on the bonds defined by “(ii)” in the chemical structure (III), and is present for these on the bonds defined by “(vii)” in the chemical structure P1, and is present for these on the bonds defined by “(ix)” in the chemical structure P2, and is present for these on the bonds defined by “(xi)” in the chemical structure P3, and is present for these on the bonds defined by “(xiii)” in the chemical structure P4, and is present for these on the bonds defined by “(xv)” in the chemical structure P5, and is present for these on the bonds defined by “(xvii)” in the chemical structure P6, and is present for these on the bonds defined in each case by “(v)” in the chemical structures (IV-1), (IV-2), (IV-3), (IV-4), (IV-5), (IV-6), (IV-7), (IV-8), (IV-9),
are not particularly restricted and are apparent from the polymerization method used in the preparation method for the polymer P_{redox2}. Thus, they may be termination fragments of an initiator or of a repeat unit. Preferably, these end groups are selected from hydrogen, halogen, hydroxyl, unsubstituted aliphatic radical or aliphatic radical substituted by —CN, —OH, halogen (which may especially be an unsubstituted or correspondingly substituted alkyl group), (hetero)aromatic radical, which is preferably a phenyl radical, benzyl radical or α-hydroxybenzyl.

### 1.4.3 Conductivity Additive L₂

### 1.4.3.1 Preferred Conductivity Additive L₂

The at least one conductivity additive L₂ which is included in the mixture M₂ which is used in step (d) of the process according to the first aspect of the invention is at least one electrically conductive material, especially selected from the group consisting of carbon materials, electrically conductive polymers, metals, semimetals, (semi)metal compounds, preferably selected from carbon materials, electrically conductive polymers.

According to the invention, “(semi)metals” are selected from the group consisting of metals, semimetals, and are preferably metals.

Metals are especially selected from the group consisting of zinc, iron, copper, silver, gold, chromium, nickel, tin, indium.

Semimetals are especially selected from silicon, germanium, gallium, arsenic, antimony, selenium, tellurium, polonium.

The conductivity additive L₂ is more preferably a carbon material. Carbon materials are especially selected from the group consisting of carbon fibres, carbon nanotubes, graphite, graphene, carbon black, fullerene.

Electrically conductive polymers are especially selected from the group consisting of polypyrroles, polyanilines, polyphenylenes, polypyrenes, polyazulenes, polynaphthylenes, polycarbazoles, polyindoles, polyazepines, polyphenylene sulfides, polythiophenes, polyacetylenes, poly(3,4-ethylenedioxythiophene) polystyrenesulfonate (=PEDOT:PSS), polyarcenes, poly-(p-phenylenevinylenes).

### 1.4.3.2 Preferred Amount of the Conductivity Additive L₂

The amount of the conductivity additive L₂ included in the mixture M₂ in step (d) of the process according to the first aspect of the invention is not subject to any further restriction. However, it is preferable that the total weight of all conductivity additives L₂ included in the mixture M₂, based on the total weight of the redox polymers P_{redox2} included in the mixture M₂, is in the range of 0.1% to 1000% by weight, preferably in the range of 10% to 500% by weight, more preferably in the range of 30% to 100% by weight, yet more preferably in the range of 40% to 80% by weight, even more preferably in the range of 50% by weight to 60% by weight, most preferably 58.3% by weight.

### 1.4.4 Solvent Solv₂

The at least one solvent Solv₂ included in the mixture M₂ is especially a solvent having a high boiling point, preferably selected from the group consisting of N-methyl-2-pyrrolidone, water, dimethyl sulfoxide, ethylene carbonate, propylene carbonate, dimethyl carbonate, methyl ethyl carbonate, γ-butyrolactone, tetrahydrofuran, dioxolane, sulfolane, N,N′-dimethylformamide, N,N-dimethylacetamide, more preferably dimethyl sulfoxide or water, even more preferably water.

More particularly, the mixture M₂ comprises a sufficient amount of solvent Solv₂ that the concentration of the organic redox-active polymer P_{redox2} in the mixture M₂ is between 1 and 100 mg/ml, preferably between 5 and 50 mg/ml.

### 1.4.5 Binder Additive B₂

More particularly, the mixture M₂ also comprises at least one binder additive B₂.

Binder additives B₂ are familiar to the person skilled in the art as materials having binding properties. Preference is given to polymers selected from the group consisting of PVdF-HFP, polytetrafluoroethylene, polyvinylidene fluoride, polyhexafluoropropylene, polyvinyl chloride, polycarbonate, polystyrene, polyacrylate, polymethacrylate, polysulfone, cellulose derivatives, polyurethane, and the binder additive more preferably comprises cellulose derivatives, e.g. sodium carboxymethylcellulose or PVdF-HFP or polyvinylidene fluoride.

In the cases in which the mixture M₂ comprises at least one binder additive B₂, the amount of all binder additives B₂ included in the mixture M₂ in step (d) of the process according to the invention in the first aspect of the invention is not subject to any further restriction.

The amount of all binder additives B₂ used, in the cases in which the mixture M₂ comprises one, is not particularly restricted. However, it is preferable in these cases that the total weight of all binder additives B₂ included in the mixture M₂, based on the total weight of the redox polymer P_{redox2} included in the mixture M₂, is in the range of 0.001% to 100% by weight, more preferably in the range of 0.1% to 90% by weight, yet more preferably in the range of 3% to 70% by weight, still more preferably in the range of 5% to 50% by weight, even more preferably in the range of 7.5% by weight to 20% by weight, and is most preferably 16.6% by weight.

### 1.4.6 Ionic Liquid IL₂

More particularly, the mixture M₂ also comprises at least one ionic liquid IL₂.

The at least one ionic liquid IL₂ included in the mixture M₂ is not particularly restricted and is described, for example, in WO 2004/016631 A1, WO 2006/134015 A1, US 2011/0247494 A1 or US 2008/0251759 A1.

More particularly, the at least one ionic liquid IL₂ included in the mixture M₂ in step (d) of the process according to the invention has the structure Q⁺A⁻.

1.4.6.1 Preferred Cation Q⁺ of IL₂
Q⁺ therein is a cation selected from the group consisting of the following structures (Q1), (Q2), (Q3), (Q4), (Q5):

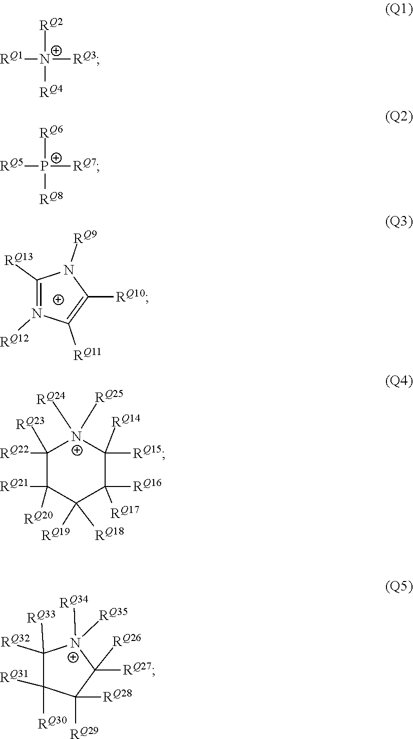

where R^{Q1}, R^{Q2}, R^{Q3}, R^{Q4}, R^{Q5}, R^{Q6}, R^{Q7}, R^{Q8} are each independently selected from the group consisting of alkyl group, haloalkyl group, cycloalkyl group,
where R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, R^{Q35} are each independently selected from the group consisting of hydrogen, alkyl group, (poly)ether group, haloalkyl group, cycloalkyl group.

Preferably, Q⁺ is a cation selected from the group consisting of the structures (Q1), (Q2), (Q3), (Q4), (Q5) where R^{Q1}, R^{Q2}, R^{Q3}, R^{Q4}, R^{Q5}, R^{Q6}, R^{Q7}, R^{Q8} are each independently selected from the group consisting of alkyl group having 6 to 40, more preferably 10 to 30, carbon atoms, cycloalkyl group having 6 to 40, more preferably 10 to 30, carbon atoms, where R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q33}, R^{Q34}, R^{Q35} are each independently selected from the group consisting of hydrogen, alkyl group having 1 to 25, preferably 1 to 10, carbon atoms, (poly)ether group having 1 to 25, preferably 1 to 10, carbon atoms.

More preferably, Q⁺ is a cation selected from the group consisting of the structures (Q1), (Q3) where R^{Q1}, R^{Q2}, R^{Q3}, R^{Q4} are each independently selected from the group consisting of alkyl group having 6 to 30, preferably 10 to 25, carbon atoms, where R^{Q9}, R^{Q10}, R^{Q11}, R^{Q12}, R^{Q13} are each independently selected from the group consisting of hydrogen, alkyl group having 1 to 25, preferably 1 to 10, carbon atoms and R^{Q10}, R^{Q11}, R^{Q13} are more preferably each hydrogen and R^{Q9}, R^{Q12} are each independently an alkyl radical having 1 to 6 carbon atoms.

Even more preferably, Q⁺ is a cation of the structure (Q3) where R^{Q10}, R^{Q11}, R^{Q13} are each hydrogen and R^{Q9} is selected from the group consisting of methyl, ethyl, n-propyl, iso-propyl, n-butyl, sec-butyl, tert-butyl, and R^{Q12} is selected from the group consisting of methyl, ethyl, n-propyl, iso-propyl, n-butyl, sec-butyl, tert-butyl.

Even more preferably, Q⁺ is a cation of the structure (Q3) where R^{Q10}, R^{Q11}, R^{Q13} are each hydrogen and R^{Q9} is selected from the group consisting of methyl, ethyl, n-butyl, preferably selected from the group consisting of ethyl, n-butyl, where R^{Q9} is most preferably ethyl, and R^{Q12} is selected from the group consisting of methyl, ethyl, where R^{Q12} is most preferably methyl.

Particularly preferred as Q⁺ is the 1-ethyl-3-methylimidazolium cation.

1.4.6.2 Preferred Anion A⁻ of IL₂

In the aforementioned formula Q⁺A⁻, A⁻ is an anion, especially selected from the group consisting of phosphate, phosphonate, alkylphosphonate, monoalkylphosphate, dialkylphosphate, bis[trifluoromethanesulfonyl]imide, alkylsulfonate, haloalkylsulfonate, alkylsulfate, haloalkylsulfate, bis[fluorosulfonyl]imide, halide, dicyanamide, hexafluorophosphate, sulfate, tetrafluoroborate, trifluoromethanesulfonate, perchlorate, hydrogensulfate, haloalkylcarboxylate, alkylcarboxylate, formate, bisoxalatoborate, tetrachloroaluminate, dihydrogenphosphate, monoalkylhydrogenphosphate, nitrate.

In the aforementioned formula Q⁺A⁻, A⁻ is preferably selected from the group consisting of phosphate, phosphonate, alkylphosphonate, monoalkylphosphate, dialkylphosphate, bis[trifluoromethanesulfonyl]imide, alkylsulfonate, alkylsulfate, bis[fluorosulfonyl]imide, halide, dicyanamide, hexafluorophosphate, sulfate, tetrafluoroborate, trifluoromethanesulfonate, perchlorate, hydrogensulfate, alkylcarboxylate, formate, bisoxalatoborate, tetrachloroaluminate, dihydrogenphosphate, monoalkylhydrogenphosphate, nitrate, where the alkyl groups in alkylphosphonate, monoalkylphosphate, dialkylphosphate, alkylsulfonate, alkylsulfate, alkylcarboxylate, monoalkylhydrogenphosphate each have 1 to 10, preferably 1 to 6, more preferably 1 to 4, carbon atoms.

In the aforementioned formula Q⁺A⁻, A⁻ is more preferably selected from the group consisting of dialkylphosphate, bis[trifluoromethanesulfonyl]imide, alkylsulfonate, bis[fluorosulfonyl]imide, chloride, dicyanamide, hexafluorophosphate, tetrafluoroborate, trifluoromethanesulfonate, perchlorate, acetate, propionate, formate, tetrachloroaluminate, monoalkylhydrogenphosphate, nitrate, where the alkyl groups in dialkylphosphate, alkylsulfonate, monoalkylhydrogenphosphate each have 1 to 10, preferably 1 to 6, more preferably 1 to 4, carbon atoms.

In the aforementioned formula Q⁺A⁻, A⁻ is even more preferably selected from the group consisting of diethylphosphate, bis[trifluoromethanesulfonyl]imide, methanesulfonate, bis[fluorosulfonyl]imide, chloride, dicyanamide, hexafluorophosphate, tetrafluoroborate, trifluoromethanesulfonate, perchlorate, acetate, propionate, formate, tetrachloroaluminate, monoethylhydrogenphosphate, nitrate.

In the aforementioned formula Q⁺A⁻, A⁻ is even more preferably selected from the group consisting of trifluoromethanesulfonate, bis[trifluoromethanesulfonyl]imide, diethylphosphate, dicyanamide, most preferably from the group consisting of trifluoromethanesulfonate, bis[trifluoromethanesulfonyl]imide, and is at the very most preferably bis[trifluoromethanesulfonyl]imide.

### 1.4.6.3 Amount of IL₂ Used

In the cases in which the mixture M₂ comprises at least one ionic liquid IL₂, the amount of the ionic liquid IL₂ included in the mixture M₂ in step (d) of the process according to the invention in the first aspect of the invention is not subject to any further restriction.

In the cases in which the mixture M₂ comprises at least one ionic liquid IL₂, however, it is preferable that the total molar amount of all ionic liquids IL₂ included in the mixture M₂ in step (d) of the process according to the invention, based on the total molar amount of all organic redox-active polymers P_{redox2} included in the mixture M₂, is in the range from 0.1% to 1000% by weight, more preferably in the range of 1% to 500% by weight, yet more preferably in the range of 5% to 200% by weight, still more preferably in the range of 40 to 160% by weight, even more preferably in the range of 80% to 120% by weight, and is most preferably 100% by weight.

1.4.6.4 Applying the Mixture M₂ to the Polymer Electrolyte Pₑₗ

The mixture M₂ can be applied to the polymer electrolyte Pₑₗ by methods familiar to the person skilled in the art.

Bar coating, slot die coating, screen printing or stencil printing are familiar to the person skilled in the art and are preferably used for the purpose.

### 1.5 Step (e) of the Process According to the Invention

After step (d) of the process according to the invention, the solvent Solv₂ is at least partly removed in step (e). The removal from the mixture M₂ that has been applied to the polymer electrolyte Pₑₗ is effected by methods known to the person skilled in the art, for example by drying under air, in the presence of inert gas (preferably nitrogen or argon) or under reduced pressure, in each case especially at elevated temperature.

On conclusion of step (e), an electrode E₂ applied to the polymer electrolyte Pₑₗ is obtained.

### 1.6 Step (f) of the Process According to the Invention

In step (f) of the process according to the invention, a second substrate S₂ is then applied to the electrode E₂. This can be accomplished by methods familiar to the person skilled in the art.

The substrate S₂ is especially selected from conductive materials, preferably from the group consisting of metals, carbon materials, oxide substances. These conductive materials may form the substrate S₂ on their own or, as is preferred in the present invention, may have been applied to nonconductive materials such as, in particular, a material selected from the group consisting of plastics, which are especially PET or polyurethane, textiles, cellulose, especially paper, wood. Useful substrates S₂ include cellulose fibres coated with carbon nanotubes (CNTs) (production described in WO 2015/100414, paragraphs [0104], [0105]).

Further preferred substrates S₂ are metal foils.

Metals that are preferentially suitable as substrate S₂ and may also be used in the form of nanoparticles or foils are selected from silver, platinum, gold, iron, copper, aluminium, zinc or a combination of these metals. Preferred carbon materials suitable as substrate are selected from carbon black, glassy carbon, graphite foil, graphene, carbon skins, carbon nanotubes (CNTs). Preferred oxide substances suitable as substrate for the electrode element are, for example, selected from the group consisting of indium tin oxide (ITO), indium zinc oxide (IZO), antimony zinc oxide (AZO), fluorine tin oxide (FTO) or antimony tin oxide (ATO), zinc oxide (ZO). Substrates S₂ used may also be mixtures of the groups mentioned, for example of metals and carbon materials, for example silver with carbon.

The form of the substrate S₂ in step (f) is not subject to further restriction. However, it is preferable when the substrate S₁ in step (a) of the process is planar; the substrate S₂ is also planar at least in the region in which the mixture M₁ has been applied in step (b). This means that the surface of the substrate S₂ which is applied to the electrode E₂ in step (f) of the process according to the invention in the first aspect of the invention is in a plane.

The substrate S₂ may overlap the electrode E₂ or cover the same area as E₂. On conclusion of step (f), a distinction is possible between two sides of the substrate S₁: One side is that on which layers E₁/Pₑₗ/E₂/S₂ are present. This is abbreviated hereinafter as side “S_{L}”. The other side is that on which layers E₁/Pₑₗ/E₂/S₂ are not present. This is abbreviated hereinafter as side “S_{N}”.

### 1.7 Characterizing Step (g) of the Process According to the Invention

In the characterizing step (g) of the process according to the invention, the substrate S₁ is shaped in the region of the substrate S₁ covered by E₁. As a result, the charge storage unit L_{org} produced in steps (a) to (f) is then likewise shaped in the region of the substrate S₁ covered by the electrode E₁ and hence a shaped organic charge storage unit L_{org} is obtained.

For this purpose, it is possible to use all processes known to those skilled in the art. These depend particularly on the type of use of the shaped charge storage unit L_{org} obtained after performance of the process according to the invention.

Especially in the preferred embodiment of the process according to the invention in which the substrate S₁ in step (a) is planar, the shaping is conducted in such a way that at least one edge K, a concave surface O_{A}, or a convex surface O_{X}, preferably at least one edge K forms in the region of the substrate S₁ covered by the electrode E₁. It will be apparent that, in the case of formation of an edge K, a concave surface O_{A} or a convex surface O_{X} in the region of the substrate S₁ covered by the electrode E₁, the charge storage unit L_{org} is also shaped.

According to the invention, an “edge K in the region of the substrate S₁ covered by the electrode E₁” is understood to mean the line of intersection of two planar, mutually adjoining and non-parallel surfaces O₁ and O₂ of the substrate S₁. Surfaces O₁ and O₂ are surfaces of the side S_{L} of the substrate S₁. The angle α at which the two at least partly planar surfaces O₁ and O₂ of the side S_{L} of the substrate S₁ intersect is not subject to any further restriction. The angle α may be selected from acute angles, right angles, oblique angles, reflex angles, particular preference being given to acute angles, right angles and oblique angles, and very particular preference to acute angles and right angles.

Acute angles are ≥0° but <90°, preferably >0° but <90°, more preferably in the range of 45° to 60°. One embodiment of the charge storage unit L_{org} according to the invention in which there is an edge having an angle of 0° is shown, for example, in FIG. 1 D.

A right angle is an angle of 90°.

An oblique angle is >90° but <180°, preferably in the range of 135° to 150°.

Edges having right and acute angles are shown, for example, in FIG. 2.

A reflex angle is >180° but <360°, preferably 270°.

An edge in the context of the invention may be a sharp edge or else a rounded edge, as shown, for example, in FIG. 3. In the latter cases, the angle α can then be determined by extending the respective surfaces O₁ and O₂ of the substrate S₁ (shown in FIG. 3 by dotted lines).

What is meant in accordance with the invention by a “concave surface O_{A}” and a “convex surface O_{X}” is that no region of the substrate S₁ covered by the electrode E₁ is planar; instead, the part of the substrate S₁ covered by the electrode E₁ is completely curved. The curvature here in the case of a concave surface O_{A} is such that the side S_{N} of the substrate S₁ is curved outward.

The curvature here in the case of a convex surface O_{X} is such that the side S_{L} of the substrate S₁ is curved outward.

A combination of concave and convex curvatures (“wavy shape”) is also possible.

### 2. Second Aspect: Charge Storage Unit According to the Invention

The present invention relates, in a second aspect, to a shaped organic charge storage unit L_{org} comprising:

a) a substrate S₁;
b) an electrode E₁ applied to the substrate S₁ and comprising at least one organic redox-active polymer P_{redox1}, at least one conductivity additive L₁, optionally at least one solvent Solv₁, optionally at least one binder additive B₁ and optionally at least one ionic liquid IL₁;
c) a polymer electrolyte Pₑₗ applied to the electrode E₁;
d) an electrode E₂ applied to the polymer electrolyte Pₑₗ and comprising at least one organic redox-active polymer P_{redox2}, at least one conductivity additive L₂, optionally at least one solvent Solv₂, optionally at least one binder additive B₂ and optionally at least one ionic liquid IL₂;
e) a substrate S₂ applied to the electrode E₂;
characterized in that
the substrate S₁ is at least partly nonplanar in the region of the substrate S₁ covered by the electrode E₁.

The charge storage unit L_{org} as per the second aspect of the invention can be produced by the process according to the invention as per the first aspect of the invention.

2.1 Substrates S₁, S₂

The two substrates S₁ and S₂ of the charge storage unit L_{org} according to the invention in the second aspect of the invention are each independently selected from conductive materials, preferably from the group consisting of metals, carbon materials, oxide substances. These conductive materials may form the substrate S₁ or S₂ on their own or, as is preferred in the present invention, may have been applied to nonconductive materials such as, in particular, a material selected from the group consisting of plastics (PET, polyurethane), textiles, cellulose, especially paper, wood. Useful substrates S₁ and/or S₂ include cellulose fibres coated with carbon nanotubes (CNTs) (production described in WO 2015/100414, paragraphs [0104], [0105]). Further preferred substrates S₁ and/or S₂ are metal foils.

Metals suitable with preference as substrate S₁ and/or S₂ are selected from silver, platinum, gold, iron, copper, aluminium, zinc or a combination of these metals. Preferred carbon materials suitable as substrate S₁ and/or S₂ are selected from carbon black, glassy carbon, graphite foil, graphene, carbon skins, carbon nanotubes (CNTs). Preferred oxide substances suitable as substrate for the electrode element are, for example, selected from the group consisting of indium tin oxide (ITO), indium zinc oxide (IZO), antimony zinc oxide (AZO), fluorine tin oxide (FTO) or antimony tin oxide (ATO), zinc oxide (ZO). Substrates S₁ and/or S₂ used may also be mixtures of the groups mentioned, for example mixtures of metals and carbon materials, for example silver with carbon.

2.2 Electrodes E₁, E₂

The electrode E₁ of the charge storage unit L_{org} according to the invention in the second aspect of the invention comprises at least one organic redox-active polymer P_{redox1}, at least one conductivity additive L₁, optionally at least one solvent Solv₁, optionally at least one binder additive B₁ and optionally at least one ionic liquid IL₁.

The organic redox-active polymer P_{redox1} in the charge storage unit L_{org} according to the invention in the second aspect of the invention is as defined under point 1.1.2.1.

The conductivity additive L₁ in the charge storage unit L_{org} according to the invention in the second aspect of the invention is as defined under point 1.1.2.2.1. The amount of the conductivity additive L₁ included in the electrode E₁ in the charge storage unit L_{org} according to the invention in the second aspect of the invention is not subject to any further restriction. However, it is preferable that the total weight of all conductivity additives L₁ included in the electrode E₁, based on the total weight of the redox polymers P_{redox1} included in the electrode E₁, is in the range of 0.1% to 1000% by weight, preferably in the range of 10% to 500% by weight, more preferably in the range of 30% to 100% by weight, yet more preferably in the range of 40% to 80% by weight, even more preferably in the range of 50% by weight to 60% by weight, most preferably 58.3% by weight.

The electrode E₁ in the charge storage unit L_{org} according to the invention in the second aspect of the invention optionally also comprises at least one solvent Solv₁. This is especially as defined in point 1.1.2.3. However, it is preferable that the electrode E₁ in the charge storage unit L_{org} according to the invention in the second aspect of the invention comprises less than 1% by weight, especially less than 0.1% by weight, of a solvent Solv₁.

The electrode E₁ in the charge storage unit L_{org} according to the invention in the second aspect of the invention optionally also comprises at least one ionic liquid IL₁. This is especially as defined in points 1.1.2.5.1, 1.1.2.5.2.

In the cases in which the electrode E₁ in the charge storage unit L_{org} according to the invention in the second aspect of the invention comprises at least one ionic liquid IL₁, the amount of the ionic liquid IL₁ included in the electrode E₁ in the charge storage unit L_{org} according to the invention in the second aspect of the invention is not subject to any further restriction.

In the cases in which the electrode E₁ in the charge storage unit L_{org} according to the invention in the second aspect of the invention comprises at least one ionic liquid IL₁, however, it is preferable that the total molar amount of all ionic liquids IL₁ included in the electrode E₁ in the charge storage unit L_{org} according to the invention in the second aspect of the invention, based on the total molar amount of all organic redox-active polymers P_{redox1} included in the electrode E₁ in the charge storage unit L_{org} according to the invention in the second aspect of the invention is in the range of 0.1% to 1000% by weight, more preferably in the range of 1% to 500% by weight, even more preferably in the range of 5% to 200% by weight, yet more preferably in the range of 40% to 160% by weight, yet more preferably still in the range of 80% to 120% by weight, most preferably 100% by weight.

In the cases in which the electrode E₁ in the charge storage unit L_{org} according to the invention in the second aspect of the invention comprises at least one binder additive B₁, the binder additive B₁ is especially as described in point 1.1.2.4.

In the cases in which the electrode E₁ in the charge storage unit L_{org} according to the invention in the second aspect of the invention comprises at least one binder additive B₁, however, it is preferable that the total molar amount of all binder additives B₁ included in the electrode E₁ in the charge storage unit L_{org} according to the invention in the second aspect of the invention, based on the total molar amount of all organic redox-active polymers P_{redox1} included in the electrode E₁ in the charge storage unit L_{org} according to the invention in the second aspect of the invention is in the range of 0.001% to 100% by weight, more preferably in the range of 0.1% to 90% by weight, even more preferably in the range of 3% to 70% by weight, yet more preferably in the range of 5% to 50% by weight, yet more preferably still in the range of 7.5% to 20% by weight, most preferably 16.6% by weight.

The electrode E₂ of the charge storage unit L_{org} according to the invention in the second aspect of the invention comprises at least one organic redox-active polymer P_{redox2}, at least one conductivity additive L₂, optionally at least one solvent Solv₂, optionally at least one binder additive B₂ and optionally at least one ionic liquid IL₂.

The organic redox-active polymer P_{redox2} in the charge storage unit L_{org} according to the invention in the second aspect of the invention is as defined under point 1.4.2.

The conductivity additive L₂ in the charge storage unit L_{org} according to the invention in the second aspect of the invention is as defined under point 1.4.3.1. The amount of the conductivity additive L₂ included in the electrode E₂ in the charge storage unit L_{org} according to the invention in the second aspect of the invention is not subject to any further restriction. However, it is preferable that the total weight of all conductivity additives L₂ included in the electrode E₂, based on the total weight of the redox polymers P_{redox2} included in the electrode E₂, is in the range of 0.1% to 1000% by weight, preferably in the range of 10% to 500% by weight, more preferably in the range of 30% to 100% by weight, yet more preferably in the range of 40% to 80% by weight, even more preferably in the range of 50% by weight to 60% by weight, most preferably 58.3% by weight.

The electrode E₂ in the charge storage unit L_{org} according to the invention in the second aspect of the invention optionally also comprises at least one solvent Solv₂. This is especially as defined in point 1.4.4. However, it is preferable that the electrode E₂ in the charge storage unit L_{org} according to the invention in the second aspect of the invention comprises less than 1% by weight, especially less than 0.1% by weight, of a solvent Solv₂.

The electrode E₂ in the charge storage unit L_{org} according to the invention in the second aspect of the invention optionally also comprises at least one ionic liquid IL₂. This is especially as defined in points 1.4.6.1, 1.4.6.2.

In the cases in which the electrode E₂ in the charge storage unit L_{org} according to the invention in the second aspect of the invention comprises at least one ionic liquid IL₂, the amount of the ionic liquid IL₂ included in the electrode E₂ in the charge storage unit L_{org} according to the invention in the second aspect of the invention is not subject to any further restriction.

In the cases in which the electrode E₂ in the charge storage unit L_{org} according to the invention in the second aspect of the invention comprises at least one ionic liquid IL₂, however, it is preferable that the total molar amount of all ionic liquids IL₂ included in the electrode E₂ in the charge storage unit L_{org} according to the invention in the second aspect of the invention, based on the total molar amount of all organic redox-active polymers P_{redox2} included in the electrode E₂ in the charge storage unit L_{org} according to the invention in the second aspect of the invention is in the range of 0.1% to 1000% by weight, more preferably in the range of 1% to 500% by weight, even more preferably in the range of 5% to 200% by weight, yet more preferably in the range of 40% to 160% by weight, yet more preferably still in the range of 80% to 120% by weight, most preferably 100% by weight.

In the cases in which the electrode E₂ in the charge storage unit L_{org} according to the invention in the second aspect of the invention comprises at least one binder additive B₂, the binder additive B₂ is especially as described in point 1.4.5.

In the cases in which the electrode E₂ in the charge storage unit L_{org} according to the invention in the second aspect of the invention comprises at least one binder additive B₂, however, it is preferable that the total molar amount of all binder additives B₂ included in the electrode E₂ in the charge storage unit L_{org} according to the invention in the second aspect of the invention, based on the total molar amount of all organic redox-active polymers P_{redox2} included in the electrode E₂ in the charge storage unit L_{org} according to the invention in the second aspect of the invention is in the range of 0.001% to 100% by weight, more preferably in the range of 0.1% to 90% by weight, even more preferably in the range of 3% to 70% by weight, yet more preferably in the range of 5% to 50% by weight, yet more preferably still in the range of 7.5% to 20% by weight, most preferably 16.6% by weight.

### 2.3 Polymer Electrolytes Pₑₗ

The polymer electrolyte Pₑₗ included in the charge storage unit L_{org} according to the invention in the second aspect of the invention is as described in point 1.3.1 and obtainable by the methods described in point 1.3.2.

### 2.4 Shaping

The charge storage unit Log in the second aspect of the present invention has additionally also been shaped. According to the invention, shaping is when the substrate S₁ is at least partly nonplanar in the region of the substrate S₁ covered by the electrode E₁, the inevitable result of which is that the layers E₁/Pₑₗ/E₂/S₂ are also nonplanar.

This is the case especially when the substrate S₁ has a concave surface O_{A}, a convex surface O_{X}, a combination of the two or at least one edge K, one edge K being the most preferred.

### 3. Figures

FIG. 1 A shows a preferred embodiment of the production process in the first aspect of the present invention. FIGS. 1 B, 1 C, 1 D show preferred embodiments of the charge storage unit L_{org} in the second aspect of the present invention.

FIG. 1 A shows how, in step (a), a mixture M₁ is applied to a substrate S₁ via a method known to the person skilled in the art, for example screen printing. The solvent Solv₁ included in the mixture M₁ is then removed at least partly, but preferably completely, in step (b), which gives an electrode E₁ applied to the substrate S₁. Then, in a further step (c), a polymer electrolyte Pₑₗ is applied to the electrode E₁. In the subsequent step (d), a mixture M₂ is applied to the polymer electrolyte Pₑₗ, from which the solvent Solv₂ is removed at least partly, preferably completely, in the subsequent step (e). This gives an electrode E₂. A further substrate S₂ is then applied thereto in step (f). This gives an organic charge storage unit L_{org}. Two sides of the substrate S₁ can now be distinguished: One side is that on which layers E₁/Pₑₗ/E₂/S₂ are present (“S.” side). The other side is that on which layers E₁/Pₑₗ/E₂/S₂ are not present (“S_{N}” side).

FIGS. 1 B, 1 C and 1 D show various embodiments in which the shaping of the substrate S₁ can be configured in the region of the substrate S₁ covered by the electrode E₁. This shaping is performed in step (g) of the process according to the invention in the first aspect of the invention. For instance, the substrate S₁ may be shaped in a convex (FIG. 1 B; O_{X}) or concave (FIG. 1 C; O_{A}) manner. These two shaping operations do not leave any planar surfaces in the substrate S₁. Alternatively, as shown in FIG. 1 D, where the substrate S₁ then has at least partly planar surfaces O₁ and O₂, the substrate S₁ can also be shaped to form an edge K.

FIGS. 2 A, 2 B and 2 C show preferred embodiments of the charge storage unit L_{org} in the second aspect of the present invention. In these embodiments, a sharp edge K is formed, in which the surfaces O₁ and O₂ of the planar faces of the S_{L} side (symbol S_{L} as shown in FIG. 1 A) of the substrate S₁ form a line of intersection and intersect at a right angle α (FIG. 2 A), an acute angle α (FIG. 2 B) or an oblique angle α (FIG. 2 C).

FIGS. 3 A, 3 B and 3 C show embodiments of the charge storage unit L_{org} in the second aspect of the present invention. These correspond to those shown in FIGS. 2 A, 2 B and 2 C, except that no sharp edge K is formed, and the edge K is instead rounded.

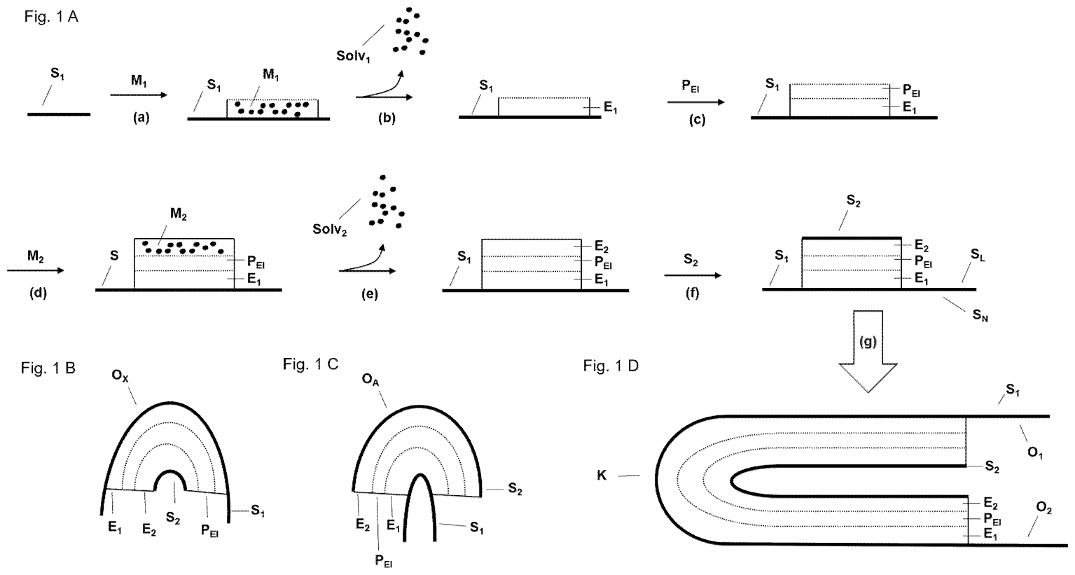

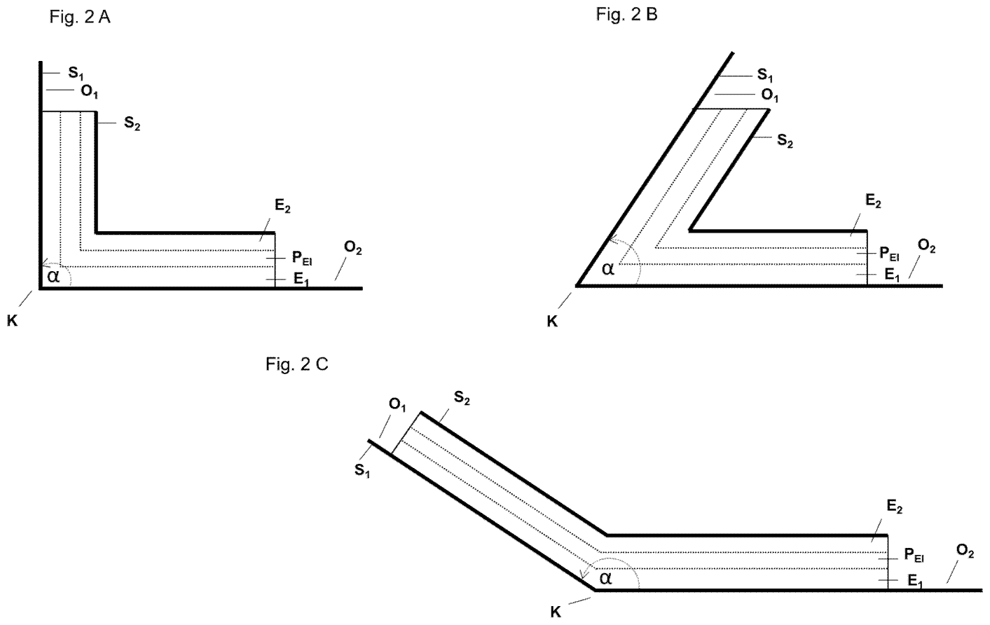

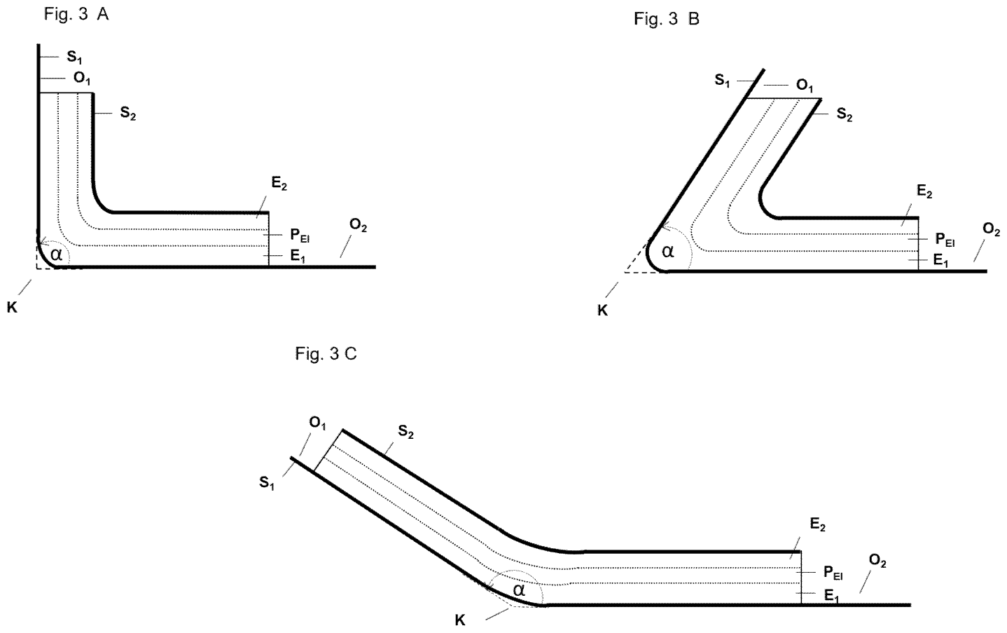

1: A process for producing a shaped organic charge storage unit L_{org}, comprising:
a) applying a mixture M₁ comprising at least one organic redox-active polymer P_{redox1}, at least one conductivity additive L₁, at least one solvent Solv₁, optionally, at least one binder additive B₁, and optionally, at least one ionic liquid IL₁, to a substrate S₁,
b) at least partly removing the at least one solvent Solv₁, to obtain an electrode E₁ applied to the substrate S₁;
c) applying a polymer electrolyte P_{d} to the electrode E₁;
d) applying a mixture M₂ comprising at least one organic redox-active polymer P_{redox2}, at least one conductivity additive L₂, at least one solvent Solv₂, optionally, at least one binder additive B₂, and optionally, at least one ionic liquid IL₂, to the polymer electrolyte Pₑₗ,
e) at least partly removing the at least one solvent Solv₂, to obtain an electrode E₂ applied to the polymer electrolyte Pₑₗ;
f) applying a substrate S₂ to the electrode E₂; to obtain an organic charge storage unit L_{org}; and
g) shaping the substrate S₁ in the region of the substrate S₁ covered by the electrode E₁, to obtain a shaped organic charge storage unit L_{org}.

2: The process according to claim 1, wherein in g), at least one concave surface or at least one convex surface or at least one edge is formed in the region of the substrate S₁ covered by the electrode E₁.

3: The process according to claim 1, wherein the substrate S₁ in a) is planar.

4: The process according to claim 1, wherein the substrate S₁ is at least one selected from the group consisting of plastics, carbon, metals, metal oxides, paper, cellulose, textiles, and wood.

5: The process according to claim 1, wherein the at least one organic redox-active polymer P_{redox1} and the at least one organic redox-active polymer P_{redox2} are each independently selected from the group consisting of polyimides and polymers comprising m units of the general formula (III): 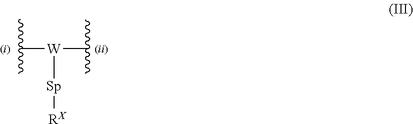
wherein m is an integer ≥4,
W is a repeat unit,
Sp is an organic spacer, and
R^{X} is an organic redox-active group,
wherein the bond identified by (i) in a unit of the formula (III) binds to the bond identified by (ii) in an adjacent unit of the formula (III).

6: The process according to claim 5, wherein the at least one organic redox-active polymer P_{redox1} and the at least one organic redox-active polymer P_{redox2} are each independently a polymer comprising m units of the general formula (III) in which R^{X} is selected from the group consisting of compounds of the general formulae (III-A), (III-B), (III-C), (III-D), (III-E), and (III-F), 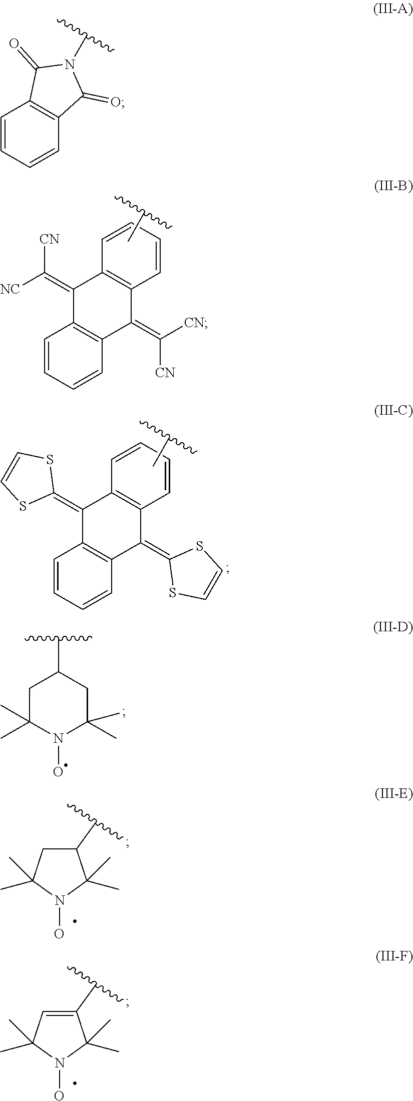
and
wherein, in the structures of the general formulae (III-A), (III-B) and (III-C), at least one aromatic carbon atom may be substituted by a group selected from the group consisting of an alkyl group, a halogen group, a alkoxy group, and hydroxyl group.

7: The process according to claim 5, wherein the at least one organic redox-active polymer P_{redox1} and the at least one organic redox-active polymer P_{redox2} are each independently a polyimide selected from the group consisting of structures (IV-1), (IV-2), (IV-3), (IV-4), (IV-5), (IV-6), (IV-7), (IV-8), and (IV-9): 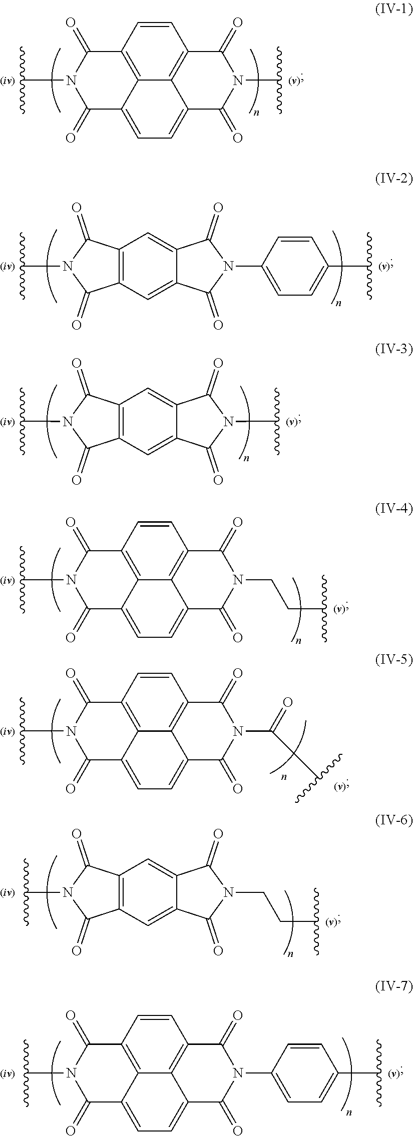 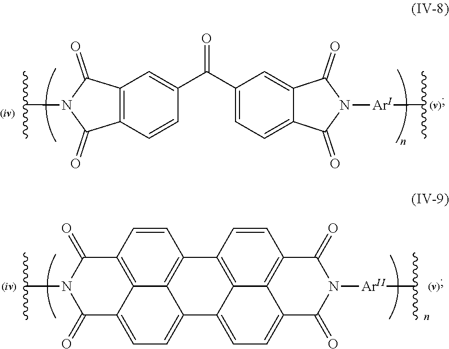
wherein each n is an integer ≥4 and the bond identified by (iv) in the structures (IV-1), (IV-2), (IV-3), (IV-4), (IV-5), (IV-6), (IV-7), (IV-8), (IV-9) binds in each case to the bond identified by (v), and
wherein Ar^{I}, Ar^{II} are each independently a hydrocarbyl group having at least one aryl radical, and
wherein in the structures (IV-1), (IV-2), (IV-3), (IV-4), (IV-5), (IV-6), (IV-7), (IV-8), (IV-9), at least one aromatic carbon atom may be substituted by a group selected from the group consisting of alkyl, halogen, alkoxy, and OH.

8: The process according to claim 5, wherein the W radical in the structure (III) is selected from the group consisting of the structures (W1), (W2), and (W3): 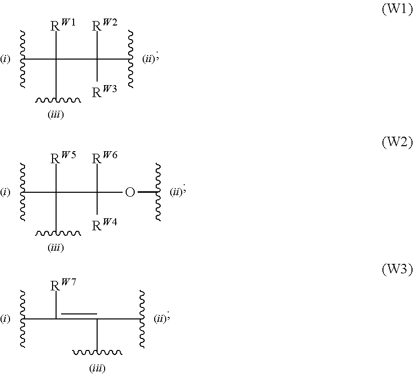
wherein the bond identified by (i) in a unit of the formula (W1), (W2), (W3) binds in each case to the bond identified by (ii) in an adjacent unit of the formula (W1), (W2) or (W3),
wherein the bond identified by (iii) identifies the bond to Sp, and
wherein R^{W1}, R^{W2}, R^{W3}, R^{W4}, R^{W5}, R^{W6}, R^{W7} are independently selected from the group consisting of hydrogen, an alkyl group, a haloalkyl group, —COOR^{W8} with R^{W8}═H or alkyl, and
wherein Sp in the structure (III) is selected from the group consisting of a direct bond, (Sp1), and (Sp2): [symbol]
-(O)_{pA1}—[C═O]_{pA2}—(O)_{pA3}—B^{Sp}—(O)_{qA1}—[C═O]_{qA2}—(O)_{qA3}- [symbol] , (Sp1): [symbol]
-(O)_{qA4}—[C═O]_{qA5}—(X^{Sp2})_{qA6}- [symbol] with X^{Sp2}═O or NH, (Sp2):
wherein pA1, pA2, pA3 are each 0 or 1, excluding the case that pA2=0 and pA1=pA3=1,
wherein qA1, qA2, qA3 are each 0 or 1, excluding the case that qA2=0 and qA1=qA3=0,
wherein qA4, qA5, qA6 are each 0 or 1, wherein at least one of qA4, qA5, qA6=1 and wherein the case that qA5=0 and qA4=qA6=1 is excluded,
wherein B^{Sp} is selected from the group consisting of
a divalent (hetero)aromatic radical, and
a divalent aliphatic radical, optionally substituted by at least one group selected from the group consisting of a nitro group, —NH₂, —CN, —SH, —OH, and halogen; and optionally, having at least one group selected from the group consisting of an ether, a thioether, an amino ether, a carbonyl group, a carboxylic ester, a carboxamide group, a sulfonic ester, and a phosphoric ester, and
wherein in the cases in which Sp binds to a non-carbon atom in the R^{X} radical, the structure (Sp1) is subject to the additional condition qA3=0, qA2=1, and qA1=1; or qA3=qA2=qA1=0; or qA3=0, qA2=1, and qA1=0, and the structure (Sp2) is subject to the additional condition qA6=0, qA5=1, and qA4=1; or qA6=0, qA5=1, and qA4=0, and
wherein [symbol] denotes the bond pointing toward R^{X}, and
wherein [symbol] denotes the bond pointing toward W.

9: The process according to claim 1, wherein the at least one organic redox-active polymer P_{redox1} and the at least one organic redox-active polymer P_{redox2} each independently comprise t repeat units joined to one another that are selected from the group consisting of the structures P1, P2, P3, P4, P5, and P6: 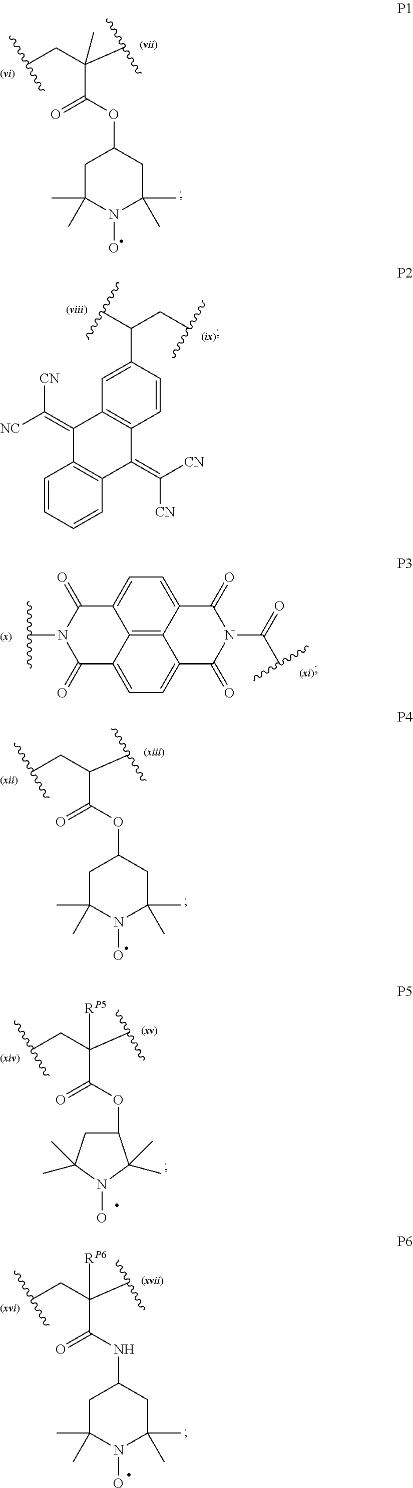
wherein t is an integer ≥4,
wherein R^{P5}, R^{P6} are each independently selected from the group consisting of hydrogen and methyl, and
wherein
the bond identified by (vi) in a unit of the formula P1 binds to the bond identified by (vii) in an adjacent unit of the formula P1, and
the bond identified by (viii) in a unit of the formula P2 binds to the bond identified by (ix) in an adjacent unit of the formula P2, and
the bond identified by (x) in a unit of the formula P3 binds to the bond identified by (xi) in an adjacent unit of the formula P3, and
the bond identified by (xii) in a unit of the formula P4 binds to the bond identified by (xiii) in an adjacent unit of the formula P4, and
the bond identified by (xiv) in a unit of the formula P5 binds to the bond identified by (xv) in an adjacent unit of the formula P5, and
the bond identified by (xvi) in a unit of the formula P6 binds to the bond identified by (xvii) in an adjacent unit of the formula P6.

10: The process according to claim 1, wherein the at least one conductivity additive L₁ and the at least one conductivity additive L₂ are each independently selected from the group consisting of carbon materials, electrically conductive polymers, metals, semimetals, metal compounds, and semimetal compounds.

11: The process according to claim 1, wherein the at least one solvent Solv₁ and the at least one solvent Solv₂ are each independently selected from the group consisting of N-methyl-2-pyrrolidone, water, dimethyl sulfoxide, ethylene carbonate, propylene carbonate, dimethyl carbonate, methyl ethyl carbonate, γ-butyrolactone, tetrahydrofuran, dioxolane, sulfolane, N,N′-dimethylformamide, and N,N′-dimethylacetamide.

12: The process according to claim 1, wherein the mixture M₁ comprises the at least one binder additive B₁ and/or the mixture M₂ comprises the at least one binder additive B₂.

13: The process according to claim 1, wherein the mixture M₁ comprises the at least one ionic liquid IL₁ and/or the mixture M₂ comprises the at least one ionic liquid IL₂, wherein IL₁ and IL₂ each independently have a structure Q⁺A⁻ in which Q⁺ is a cation selected from the group consisting of the structures (Q1), (Q2), (Q3), (Q4), and (Q5): 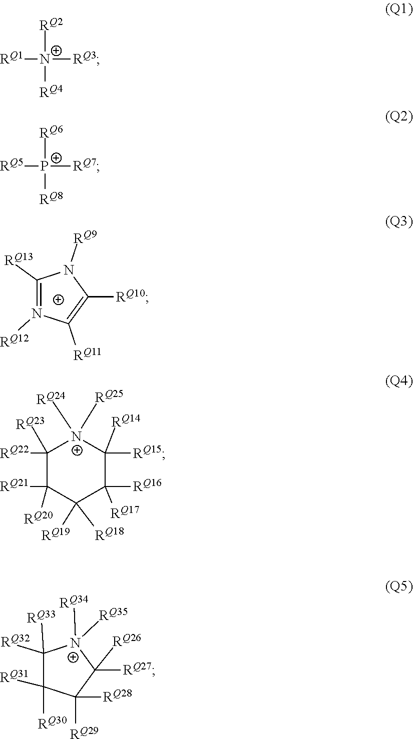
wherein R^{Q1}, R^{Q2}, R^{Q3}, R^{Q4}, R^{Q5}, R^{Q6}, R^{Q7}, R^{Q8} are each independently selected from the group consisting of an alkyl group, a haloalkyl group, and a cycloalkyl group,
wherein R^{Q9}, R^{Q10}, R^{Q11}, R^{Q12}, R^{Q13}, R^{Q14}, R^{Q15}, R^{Q16}, R^{Q17}, R^{Q18}, R^{Q19}, R^{Q20}, R^{Q21}, R^{Q22}, R^{Q23}, R^{Q24}, R^{Q25}, R^{Q26}, R^{Q27}, R^{Q28}, R^{Q29}, R^{Q30}, R^{Q31}, R^{Q32}, R^{Q33}, R^{Q34}, R^{Q35} are each independently selected from the group consisting of hydrogen, an alkyl group, a (poly)ether group, a haloalkyl group, and a cycloalkyl group, and
wherein A⁻ is an anion.

14: The process according to claim 1, wherein the polymer electrolyte Pₑₗ is obtained by polymerizing a mixture M₃ comprising compounds of the formula (I) and/or compounds of the formula (II): 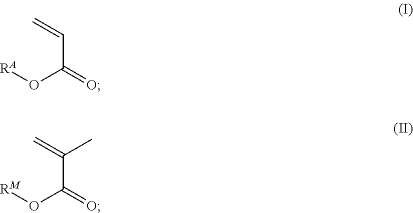
wherein R^{A}, R^{M} are independently selected from the group consisting of hydrogen, an alkyl group, a (poly)ether group, an aryl group, an aralkyl group, an alkaryl group, and a haloalkyl group, and
wherein the mixture M₃ optionally comprises at least one ionic liquid IL₃.

15: A shaped organic charge storage unit L_{org}, comprising:
a) a substrate S₁;
b) an electrode E₁ applied to the substrate S₁ and comprising at least one organic redox-active polymer P_{redox1}, at least one conductivity additive L₁, optionally, at least one solvent Solv₁, optionally, at least one binder additive B₁, and optionally, at least one ionic liquid IL₁;
c) a polymer electrolyte Pₑₗ applied to the electrode E₁;
d) an electrode E₂ applied to the polymer electrolyte Pₑₗ and comprising at least one organic redox-active polymer P_{redox2}, at least one conductivity additive L₂, optionally, at least one solvent Solv₂, optionally, at least one binder additive B₂, and optionally, at least one ionic liquid IL₂;
e) a substrate S₂ applied to the electrode E₂;
wherein the substrate S₁ is at least partly nonplanar in the region of the substrate S₁ covered by the electrode E₁.

16: The process according to claim 7, wherein in the structures (IV-1), (IV-2), (IV-3), (IV-4), (IV-5), (IV-6), (IV-7), (IV-8), and (IV-9), at least one aromatic carbon atom may be substituted by halogen or OH.

17: The process according to claim 12, wherein the at least one binder additive B₁ and the at least one binder additive B₂ are each independently selected from the group consisting of polytetrafluoroethylene, polyvinylidene fluoride, polyhexafluoropropylene, polyvinyl chloride, polycarbonate, polystyrene, polyacrylate, polymethacrylate, polysulfone, a cellulose derivative, polyurethane, and poly(vinylidene fluoride-co-hexafluoropropylene).

18: The process according to claim 13, wherein A⁻ is selected from the group consisting of phosphate, phosphonate, alkylphosphonate, monoalkylphosphate, dialkylphosphate, bis(trifluoromethanesulfonyl)imide, alkylsulfonate, haloalkylsulfonate, haloalkylsulfate, alkylsulfate, bis[fluorosulfonyl]imide, halide, dicyanamide, hexafluorophosphate, sulfate, tetrafluoroborate, trifluoromethanesulfonate, perchlorate, hydrogensulfate, haloalkylcarboxylate, alkylcarboxylate, formate, bisoxalatoborate, tetrachloroaluminate, dihydrogenphosphate, monoalkylhydrogenphosphate, and nitrate.
